(19) United States
(12) Patent Application Publication
(10) Pub. No.: US 2011/0055005 A1
(43) Pub. Date: Mar. 3, 2011

(54) System and Method of Delivering Ads

(76) Inventor: Brook W. Lang, Issaquah, WA (US)

(21) Appl. No.: 12/702,250

(22) Filed: Feb. 8, 2010

Related U.S. Application Data
(60) Provisional application No. 61/150,668, filed on Feb. 6, 2009.

(51) Int. Cl. G06Q 30/00

(52) U.S. Cl. 705/14.45; 705/14.53; 705/14.46

(57) ABSTRACT

An ad delivery and payment system over a wide area network wherein a system server which transmits ads to end users via their mobile devices who then completes a sales transactions for a good or service at the advertiser's store. The system server then reviews the advertiser's sales transactions database for customers names that match the names of end users who received the ads. The system includes an end user database that contains a plurality of end users signed up for the service and an advertiser's database containing a plurality of advertisers signed up for the service. When an ad is delivered to an end user, the name of the end user the nature of the ad and the name of the end user is recorded in the advertiser's ad delivery folder. When a customer completes a sales transaction using his or her credit or debit card, the name of the customer and the purchased product(s) or service(s) are recorded in the advertiser's sales transaction folder. A name matching software program and a query software program are then used to filter and sort the names to find matching names. In necessary, the query software program may use different filtering factors to create more accurate matching results. A report is then generated showing the total number of end users who completed a transaction is prepared which is used to determine the total revenue generated and the return on investment for the advertising campaign.

This utility patent application is based on and claims the priority filing date of U.S. Provisional Patent Application (Ser. No. 61/150,668) filed on Feb. 6, 2009.

### COPYRIGHT NOTICE

Notice is hereby given that the following patent document contains original material which is subject to copyright protection. The copyright owner has no objection to the facsimile or digital download reproduction of all or part of the patent document, but otherwise reserves all copyrights whatsoever.

### BACKGROUND OF THE INVENTION

1. Field of the Invention

This invention pertains to on-line advertising systems and methods and more particularly, to such systems and methods that enable product manufacturers, service providers, or retail businesses of these products and services to advertise to potential customers via their mobile device, and then accurately determine the effectiveness or return on Investment (RIO) via an ad spend ration to revenue and profits and other reports of the advertising campaign.

2. Description of the Related Art

The cost effectiveness or the ratio of investment of dollars spent on advertising and the sales revenue and profit is a common concern for most companies. With most advertising campaigns, a particular type of media, such as print media, broadcast media, or on-line media, is selected that is most likely to reach the company's potential customers. For most companies, it is very difficult to accurately determine what impact the type of media used in the advertising campaign has on the sales revenue and profits of the company's goods and services in a physical store location. This is especially troublesome with advertising campaigns involving non-printed media, such as radio or television broadcast media, because they typically do not use items that customers present or turn in at the point of sale. It is even further exacerbated if more than one type of media advertising is being conducted at the same time which is many times the case.

Typically, the success of a particular advertisement campaign is determined by retrospective, comparative studies of sales for the time periods just prior to the date the advertising campaign was commenced, during the advertisement campaign, and immediately following the advertisement campaign.

Over the last ten years, interactive on-line advertising, such as webpage ads, email ads, on-line discount codes (mostly for entering into on-line purchases), or downloaded discount coupons to then print have become very popular. These types of “interactive ad forms” of advertisements have been able to track effectiveness, but only of the “on-line” sales transactions (usually where a delivery service delivers the on-line purchased items to the shipping address specified in the on-line transaction) and thus not able to track the sales revenue and profit of any in-store physical location sales for customers who want to use the actual physical point of sale cash register system in the physical location store to purchase products or services (and were the advertisement is not coupon and available to every consumer that walks into the store, or without using a printed paper type coupon, or without interaction that is required between a consumers device and either the POS or cashier person, or specifically the consumer and the cashier person or POS system). Because many mobile devices are multi-functional, many users use their mobile devices as a primary tool for receiving advertisements and shopping for products and services. Advertisers are interested in new advertising campaigns specifically designed for mobile device users that offer a reasonable, verifiable return on investment of their advertising spend via confirmed sales revenue and or profit from mobile device advertisements for physical location in store sales.

What is needed is an advertising system that can measure the effectiveness of a manufactures or retailers, from a global brand down to a small business, of their advertising spend and the ratio between their in physical location store sales revenue and profit. Such a system should not require any additional computer hardware and or software in the retail store or at the store cash register or point of sale system, no retraining and or additional steps for the cashier person, and no additional steps and or any interaction whatsoever of the end user consumer with the cashier person or the point of sale cash register, and no interaction or steps with the end user consumers mobile device. Such a system should also allow the purchase price to be reduced or credit applied immediately or shortly after the sale is consummated if the advertisement is some kind of a discount that is to be specific for a select group of customers such as a coupon. Such a system should be able to be adaptable so that certain discounts and rebates are targeted and only sent to customers that need an incentive or enticement to purchase the goods or services that would or might not have otherwise.

### SUMMARY OF THE INVENTION

The above needs are met by the system and method of delivering ads to consumers who operate mobile devices and then determining whether the delivery of the ad to a registered consumer, hereinafter called an ‘end user’ led to a sales transaction at the advertiser's physical location store or in the case of the advertiser being a manufacture a sales transaction at a physical store where the advertiser manufactures items are sold. Advertisers that signed up with the system make available the sales transaction databases of customers who conducted a sales transactions within a time period and at one or more physical stores located in the region where the mobile device end user and non registered end user is located. The system server or a remote server 230 then reviews the advertiser's sales transactions database for matching names and or an identifier linked to the registered end users who received the ads. A report is generated that shows the matching names or identifiers in the two databases and the related information to the transaction. The data in the report shows the overall effectiveness of the advertising campaign in relation to the overall cost of the advertising campaign on the system server to the mobile devices paid to the service provider and the ratio between the advertisers cost and the sales revenue and profit from registered end users that purchased products or services of the advertiser.

As stated briefly above, the service operates a system server that is connected or linked to the wireless or wired network used by mobile devices used by a plurality of consumers. Loaded into the system server is an end user consumer sign-up program that allows new end users to sign up for the service. After the sign-up process is completed, a mobile client software program is downloaded into the end user's mobile device that enables the mobile device to communication with a host software program on the system server. During the sign-up process, a minimal amount of information is requested from each end user, such as his or her full name and at least one location identifier, (i.e home city, state, or zip code), which is stored in an end user information folder located in an end user database located on the system server. The end user may through the mobile client software either search the ad files on the system server in several different ways for ads for particular products and or services, or may request that ads be automatically delivered to them. A major advantage to the system is social security numbers, bank account numbers, credit card numbers, debit card numbers, or other types of identifier information other then the initial minimal information is not required.

When an end user is using the client software application, the client software application connects to the system server and thus the system server knows which end user it is. Or when an end user contacts the system's website for example via a web browsers the end user logs onto the system or the system reads some identifier information placed on the end users device and thus the system server knows which end user it is. Or when an end user views an ad delivered to the device in several other different possible ways, the ad may contain software code that looks for the mobile client software program or some other type of identifier (that the identifier can be correlated with a system registered end users) or another identifier that is related to the system and the client software that possibly the system or client software placed the identifier on the device and thus that the end users is a registered end user on the system and thus the system knows that it is a registered end user. Further, if a non-registered end user clicks on a delivered advertisement and if the client software program is not found on the mobile device, the system server then may inform the consumer that he or she is not a registered end user before displaying or going to the full page or linked ad. The system server then may give the consumer an opportunity to become a registered end user by completing the sign-up process and then after the end user has completed the sign up process then display the ad or allow the link to the ad.

As stated above, each end user file contains the names of a particular end user, a location identifier associated with the end user. In most instances, the end user's mobile device identifier (normally a telephone number) is also provided. Also associated with each end user file is an ads delivered database containing records of ads delivered to each end user and its date and time of delivery. Optionally, the ads delivery database may also include the recorded location of the end user, when the ad was delivered to the end user.

Also located on the system server is an advertiser database containing the names of advertisers signed up for the service. During the sign-up process, the physical location of each store associated with the advertiser can be submitted. Associated with each advertiser file is an ad delivery file containing the actual ad or an identifier associated therewith, and the dates and times the ad was delivered to the end users. Each ad in the ad database is associated with a publication date or a lifespan value.

Each advertiser for all of the features of the system to work must be linked to the advertisers' sales transaction database via a remote server 230 or have entire sales transaction data base download to the system server. For large companies (called national brand advertisers) that operate their own large network operation centers that process or have sales transaction records ‘in house’ of their sales transactions, a copy of the advertiser's sales transaction database covering the time period immediately following the date of delivery of the ad is made available to the system server, again via a remote server 230 operated in the national brands network operation center or via download to the system server. For businesses (called small/mid-size advertisers) that use outside merchant card services or banks to process their credit and debit card transactions and do not have their own sales transaction database in house with the required information for the system, the sales transaction database at the merchant card service or bank must be made available to the system or remote server 230. There is a “matching” of end users that received ads and all customers (end users and non-registered end users make up all customers. Consumers are all mobile device users in the world) of sales transactions of the advertisers physical stores and the process of the “matching” can be done on the system or remote server 230. In both scenarios, the sales transaction database can contain records of the total sales transactions conducted at all and at each particular store, the identification or location of all and each store, the time and or date of sales transactions, the name of the customer and non-registered customers (customers are end users that are registered on the system and completed a sales transaction and non-registered customers are end users that are not registered on the system and completed a sales transaction) who purchased a good and or service, and the nature of or identification of the goods and services purchased, the price of each item purchased, the tax amount of each item purchased, the total tax amount and the total sales revenue amount, and a receipt or transaction number.

Once the sale transaction database is available to the remote or system server, a query software program is then used to determine if the names or identifiers of all the customers in the sales transaction databases that used a credit card or debit card or other type of end user identifier payment method matches any of the names of the end users in the advertiser's ads delivered database that received an ad that subsequently made a purchase after the ad was delivered. When the query software program is executed, it first determines whether the end user's name is unique or common. For names considered to be common, the query software program may perform one or more additional filtering steps or subroutines to determine (with reasonable certainty) that of all customers listed in the sales transaction database that the end user who received the ad in question is one of the customers listed in the sales transaction database.

Using the matching information generated by the query software program, a report generating software program is then used to generate final and real-time reports informing the advertiser of a plurality of information from end users who received an ad and then completed a sales transaction. The final report may include a: total sales revenue and tax charged, total sales revenue and tax charged on the item that was advertised, a profit on all the items and the items that was advertised, a ROI and ROI ratio based on the cost of the advertisement campaign on the system, as well as many other possible parameter selected from the advertiser to generate a plurality of custom reports.

A key feature of the system is the client side software program that not only allows the end user's mobile device to communication with the host software program on the system server, but also can optionally place another identifier of some type on the device, sometimes referred to as a cookie, into or onto the mobile device outside the client software program used by an end user. This other identifier and or the client software itself is used by ads delivered to devices outside the mobile client software that the ads look for and search for the client side software or identifier place somewhere else outside the mobile client software on the device to determine if the device user is an actual registered end user on the system (it is also understood that the identifier or cookie can be placed on the device in several other ways also besides the client software placing it during software installation or it being repeatedly place on the mobile device as needed after installation by the client software or other means). Once registered, the client side software program allows the end user to search for all ads in all the advertiser's ads database on the system server. Typically, the end user tells the system server the goods or service he or she is interested in, and a location base service (such as a GPS feature, or wireless carrier network location service or manual self location in inputting the current or future location by the end user on the mobile device) on the mobile device automatically transmits the end user's location with the search request. Once an ad is found or plurality of ads, the client side software program may allow the end user to selectively ‘save’ the ad or ads on his or her mobile device. In some instances, the client side software program may collect location information of the end user when an ad is delivered to the end user's mobile device. In some instances, the client side software program may transmit the location information of the end user to the system server when a sales transaction is completed such as is used with a coupon feature or if the mobile device is an end users electronic wallet and payment device. In some instances, the client software program may include a location based messaging feature that automatically informs the end user of ads offered by advertisers as he or she moves in a region. Further, in some instances, the client side software program may also present a menu page that allows the end user to input his or her loyalty card or club card numbers into a loyalty card or club card database on the system server. Further, the client side software program may allow the end user to manually input a UPC so they can be transmitted the UPC to the system server if a camera or scanner is not used that is incorporated on the mobile device to send the UPC. The system can be used to send mobile banner ads (to websites and mobile device applications) and SMS messages, and MMS messages on the systems Ad Network to all wireless consumers' devices. The mobile client software can have a “single brand” solution where the end user can only view and interact with ads from a particular single brand. The system can be used to send messages to the mobile device or ads from advertisers that the end user has opted into received push messages on their mobile device only from specific single brands. The system can be used with the mobile client software to forward ads and messages from end users to all consumers as part of a viral marketing and social networking feature and function and additionally with this feature the ads can be interacted with outside social networking sites to be forwarded.

Another important feature of the system and method is that for end users who will receive ads, that the ads can be modified at any time, like the nature of the ads (different products and service, price or discounts, color size, graphic art, etc.) in that the ads in the ads database may be changed or modified or canceled at any time, the dates and times of delivery of the ads may be changed at any time. Another key feature is that advertisers can determine whether or not the ad is effective relatively quickly after the ad has started to be delivered. Another key feature is that sales transaction database can be reviewed and reports generated quickly and in real-time and used to determine the return on investment of the ad campaign and if the ad spend ratio to revenue and or profit is meeting the advertisers expectations.

The system is designed so that advertisers pay for the delivery of ads delivered to end users and all wireless consumers who then visit a physical location store and purchase the goods or services listed in the ads or some other item in the store (known as a off-advertised item purchase). The service is compensated by either charges for the ads placed on the system, charges for the ads delivered/viewed in pull or push form, charges for secondary clicks through from the ads, and or charges for sales transactions completed per transaction or percentage of sales revenue or profit bases on end users who received the ad and then visited a nearby store and actually purchased the advertised or off-advertised item referred to here.

A clear understand of the system is that there are four major components to complete the overall system in order to offer all the features in the system: first, the use of a mobile client software program; second, the use of a remote server and access to the sales transaction records of the store where the products or service is sold; third, the use of an ad network to deliver ads over a mobile wireless network for example banner ads to mobile web sites and or mobile device software applications; and fourth, the use of an ecosystem-type platform where when one advertiser incentivizes a non registered end user to become a registered end user and install the mobile client software on their device (and thus possibly some of the other device identifiers placed on the device outside the mobile client software too) the software functions and enables all the features and functions of the system for all advertisers on the system even if there is no direct relationship between all the other advertisers (besides the first advertiser that paid for advertising that ultimately then incentivized the end user to become a registered end user) and the registered end user. Thus meaning the big advantage to the system and why it is an eco-system is the second advertiser can do push ad marketing on the system and benefit from the first advertiser that now the second advertiser can tell from the reports that an end user who merely received and viewed a banner ad or SMS ad message or MMS ad message and never even clicked or interacted with the ad where it reported back to the service if that end user did actually end up purchasing the product or service advertised.

### DESCRIPTION OF THE DRAWINGS

FIG. 1 is an illustration of an overview of the system operated by a service that operates a system server that delivers ads for national and small/mid-size advertisers to registered end users hat can also be used by ad aggregator advertisers, real time messaging advertisers, banner ad advertisers, website and game publisher advertisers.

FIG. 2 is an illustration of the system server showing the host, end user, name matching, query, ad delivery, advertiser signup, ads creation, and report generation software programs loaded therein.

FIG. 3 is an illustration showing a mobile device, such as a mobile phone, adapted to communicate with a wireless communication network, that has a display, a browser, a location identification feature, a camera, input keys, text messaging feature, and a client side software program that includes a bundle of other software application used by the system disclosed here.

FIG. 4 is an illustration of the system server with an end user database created thereon that contains at least one end user file created for each registered end user that contains a name data folder, a location data folder, a mobile device ID data folder, an end user ads delivered folder, and an ads delivered location data folder.

FIG. 5 is an illustration of the system server with an advertisers database created thereon that contains at least one national or small/mid-size advertiser file created for each registered small/mid-size advertiser that contains a name of advertiser folder, a store location folder, an ad folder, an ads delivered folder, a reports folder, an optional sales transaction folder, and a merchant Card Processor Folder used by small/mid-size advertisers.

FIG. 6 is an illustration of an ad showing some of the key word terms associated with the ad.

FIG. 7 is a illustration of a mobile device showing show a search is narrowed.

FIG. 8 is an illustration of the mobile device showing the ad presented to the end user on the display.

FIG. 9 is an illustration showing the overall system used with a national brand advertiser.

FIG. 10 is an illustration shown three possible arrangements of the system server and the advertiser's sales transaction database.

FIG. 11 is a diagram showing how the name matching and query software programs are used to generate a report.

FIG. 12 is a diagram showing the system being used by small to mid-size business that use an external or outside merchant card processor or bank to process its credit card, debit card or gift card transactions.

FIG. 13 is a diagram showing the system being used by an advertisement aggregator that sells and delivers their own inventory of mobile advertisements sold to their advertising customers to their own inventory of advertisement receiving inventory of end-user consumers.

FIG. 14 s a diagram showing a mobile message is a diagram showing a SMS/MMS message delivery service coupled to the system server.

FIG. 15 is a diagram showing a banner ad network coupled to the system.

FIG. 16 is a diagram showing a mobile website banner service coupled to the system.

FIG. 17 is an illustration showing the system used with a location based message service that notifies the system server when an end user is in the vicinity of the advertiser's store and the system server then delivers the advertiser's ad to the end user's mobile device.

FIG. 18 is an illustration showing the system used with a UPC feedback feature in which end user's who provide feedback concerning the price, quality or features of a product or service offered by an advertiser is sent a discount coupon in return.

FIG. 19 is an illustration showing system used with a loyalty, gift or club card feature where the card number assigned to the end user is used during the sales transaction and then used to identify the end user.

FIG. 20 is a diagram showing how the final reports are generated.

FIG. 21 is an illustration of the final report shown the total revenue generated, the derived profit, the dollar value of the ration of profit to $1.00 spent, the total number of views, total clicks from the ads, total amount of revenue charged and the total cost of the service.

### DESCRIPTION OF THE PREFERRED EMBODIMENT(S)

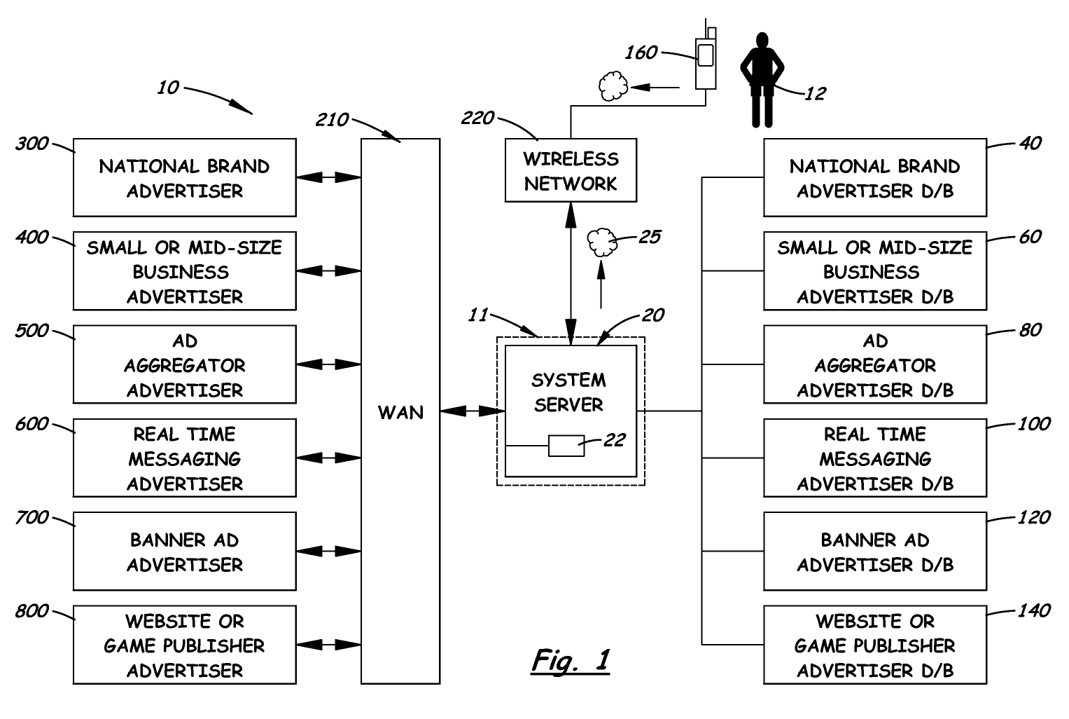

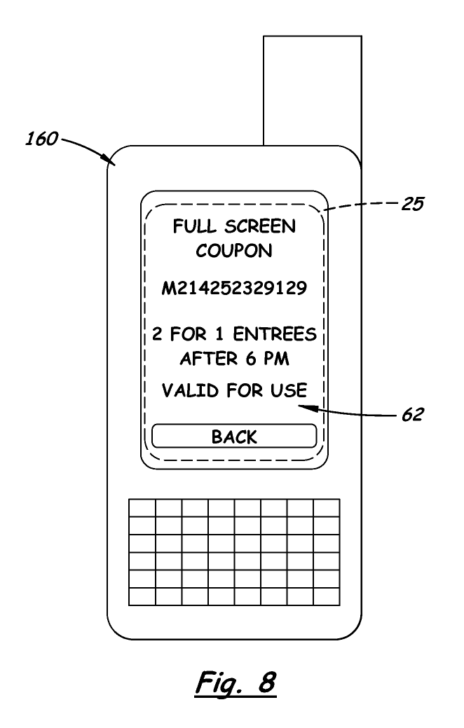

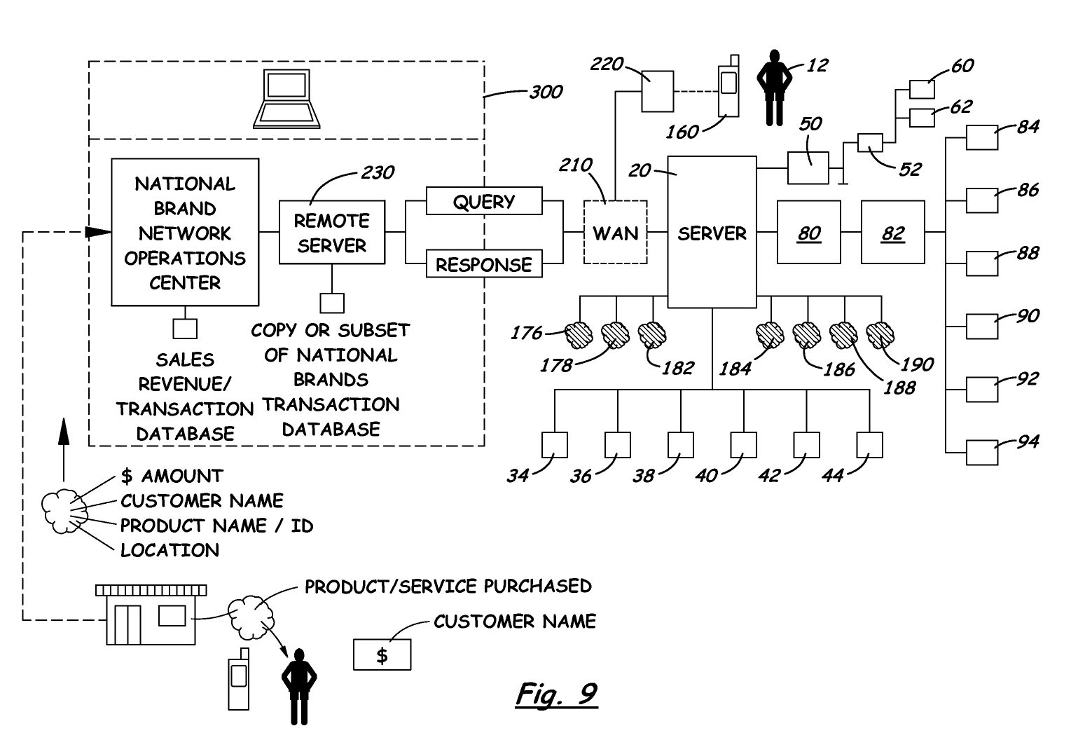

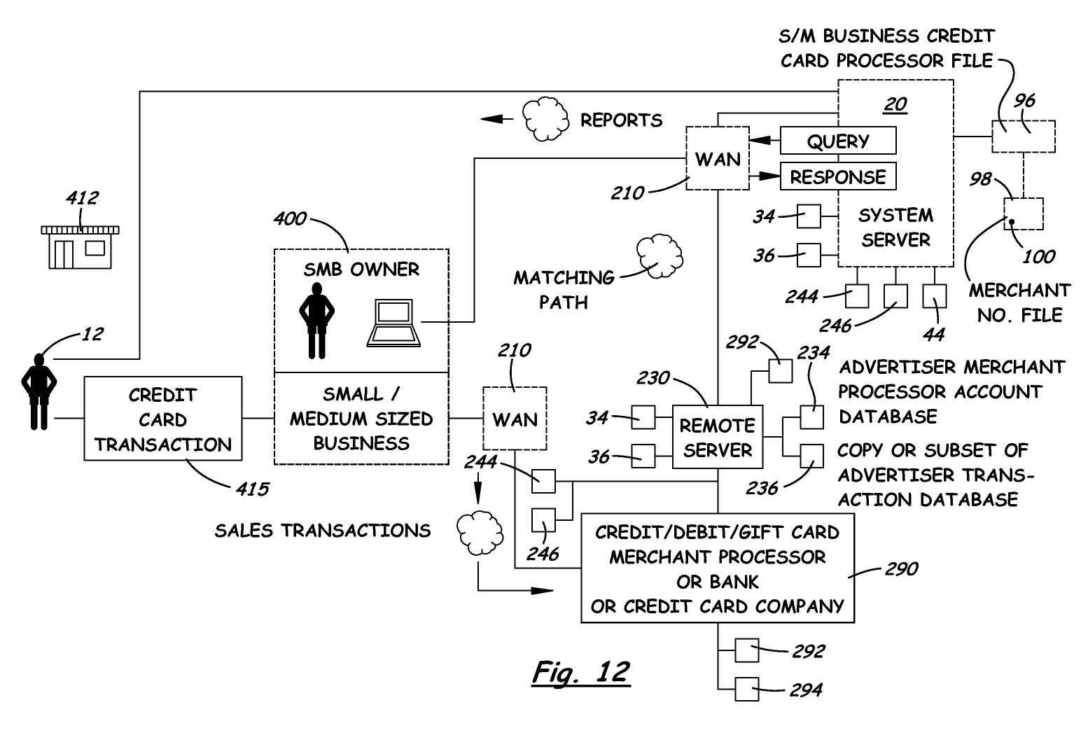

Referring to the accompanying FIGS. 1-20, there is shown a system 10 used by large and small/mid-size advertisers that companies can be either or both a retailer or a manufacturer company or both that sell their products or services in retail locations and that want to deliver sales or promotional materials, such as advertisements, discount coupons, rebate offers, etc, generally referred to as ‘ads,’ and indicated by the reference number 25, to a plurality of all consumers. More specifically, the ads 25 are delivered by the system 10 to the mobile devices 160, which may be any mobile electronic apparatus including but not limited to a computer, personal navigation device, in-vehicle computer systems or in-vehicle in-dash navigation systems, laptop computer, netbook computer, or a mobile telephone operated by the consumers. The consumers may be either end users registered on the system 10 and indicated by the reference number 12 or non-registered end-users, indicated by the reference number 12′. It should be understood that the term ‘customers’ as used herein are individuals that have purchased and completed a sales transaction at a physical store operated by an advertiser or is selling goods or services from an advertiser and include both registered non-registered end users.

The ads 25 are created and placed on the system 10 by advertisers who also must be registered on the system 10. Generally, there are two types of advertisers—national brand advertisers, indicated by the reference number 300 and small/mid-size advertisers indicated by the reference number 400. National brand advertisers are defined as companies that operate a computer network operation center (also known as a NOC) that has its company's sales transaction records including items purchased by their customers and through credit card type transactions data with and or where the retailer can get the consumers names or other identifier information on the sales transaction record. Small/mid-size advertisers 400 are small to med-size businesses, that operate from a single store to a plurality of physical stores in small region to a large region that do not operate a computer network operation center that records the company's sales transaction records at its facility with customers names or identifiers on the records that are available but instead uses a bank or credit card company to process all credit and debit card type transactions where the names or other identifier information is available. It should be understood that each advertiser 300, 400 may be a product manufacturer or a service provider or it may be a company that operates retail stores that sell their products or another company's products and services. It should also be understood that the term ‘store’ may be a physical store operated by the advertiser but can also be an online retail website.

For illustration purposes, the system 10 is described as being operated by an ad delivering service 11 that delivers ads 25 for products or services to the mobile device 160 operated by an end user 12, The system 10 may deliver the ads 25 in real time or at a predetermine date and time through a verity of delivered and received ways. When an end user 12 visits the advertiser's store and completes a sales transaction using his or her credit or debit card or other identifiable means of payment, it is recorded in the advertiser's sales transaction records. The system 10 uses a system server 20 or a remote server 230 to access the advertiser's sales transaction records. Information regarding the end user's name, his or her recorded home location or the general location at the time the ad 25 is sent or viewed by the end user 12 is recorded by the system server 20. Also, the parameters of the product or service contained in the ad 25 may be is compared with the names of all the customers, all the store locations or a narrowed set of store locations, and all the parameters of the product or service on the sale transaction records. After comparing this information, matches of end users and customers are made. A statistical analysis projection is used using several factors to come up with probable matches and percentage degree of the accuracy of the designated matches that indeed, the end user 12 and a particular customer sales transaction are the same individual.

### Reporting Embodiment

Using the above described system 10, a report 125 is then prepared that uses the matching data information to inform the advertiser 300, 400 of the cost effectiveness of the service. From the matching data, an advertiser 300, 400 can view the report 125 that contain all the goods and services purchased with all the related data to the items. A report 125 can include all goods and services purchased and were advertised and all the related data to these items too. Then a ROI and ratio information can be presented in the report 125 that shows the cost of the ads run can be compared to one or both of a sales revenue and sales profit reports information to derive a ratio of ad dollars spend to sales revenue or sales profit to decide if the ad campaign is meeting the advertisers ROI ratio expectations. These reports 125 can be run historically and also be calculating and displaying in real-time on what is commonly called a real-time dash board report 125

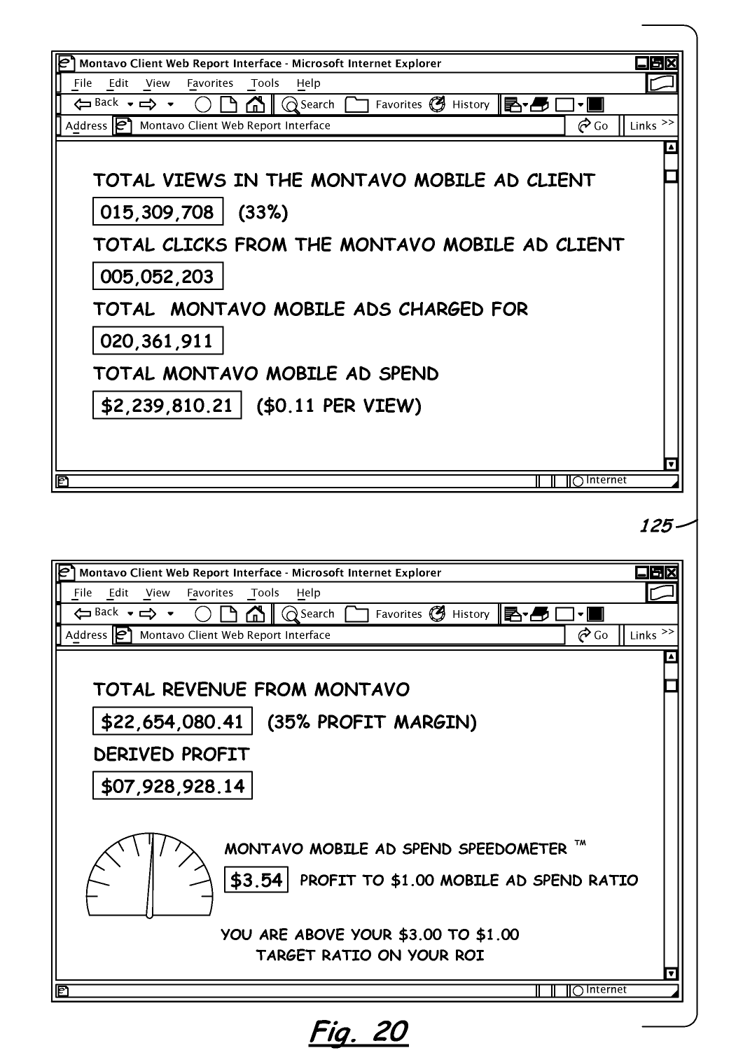

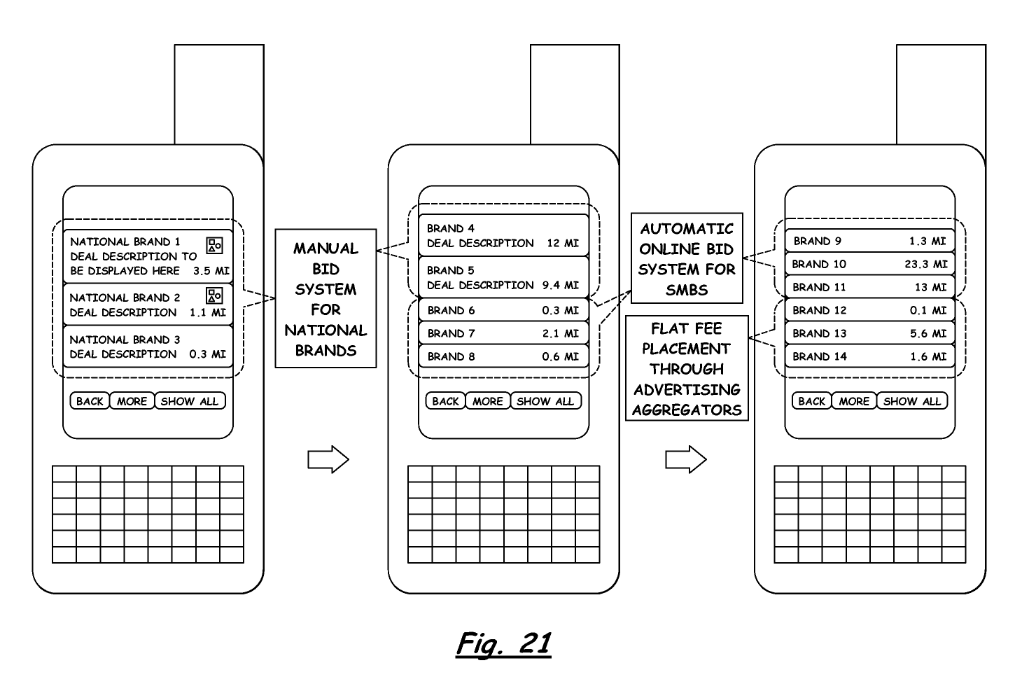

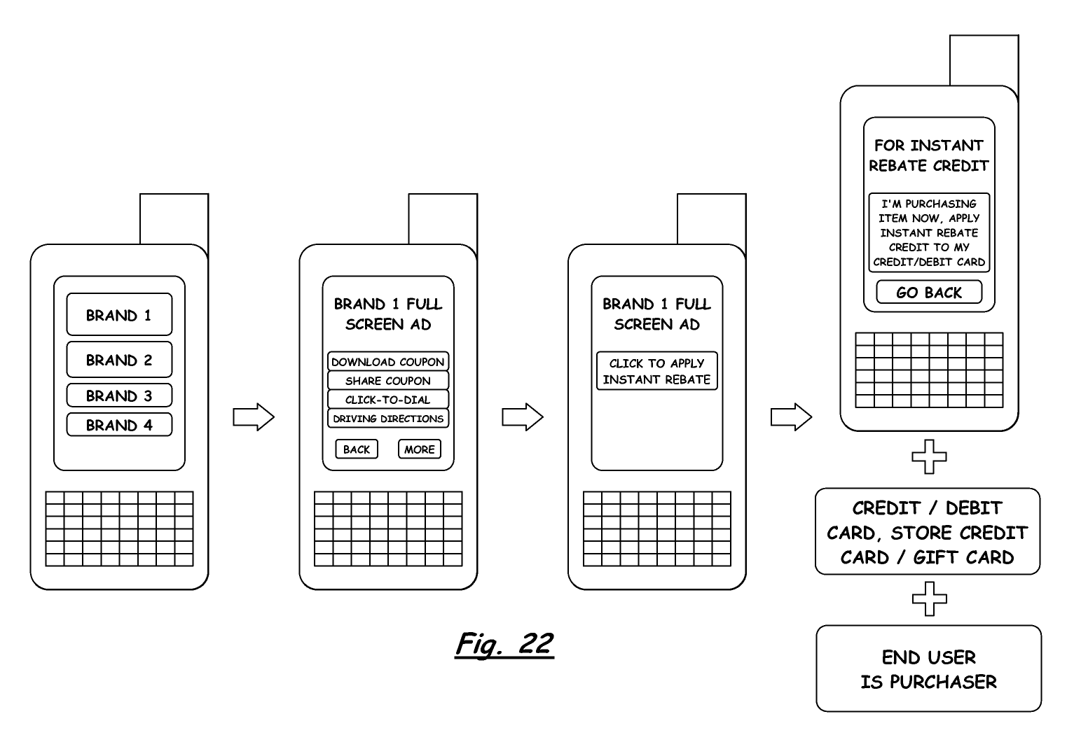

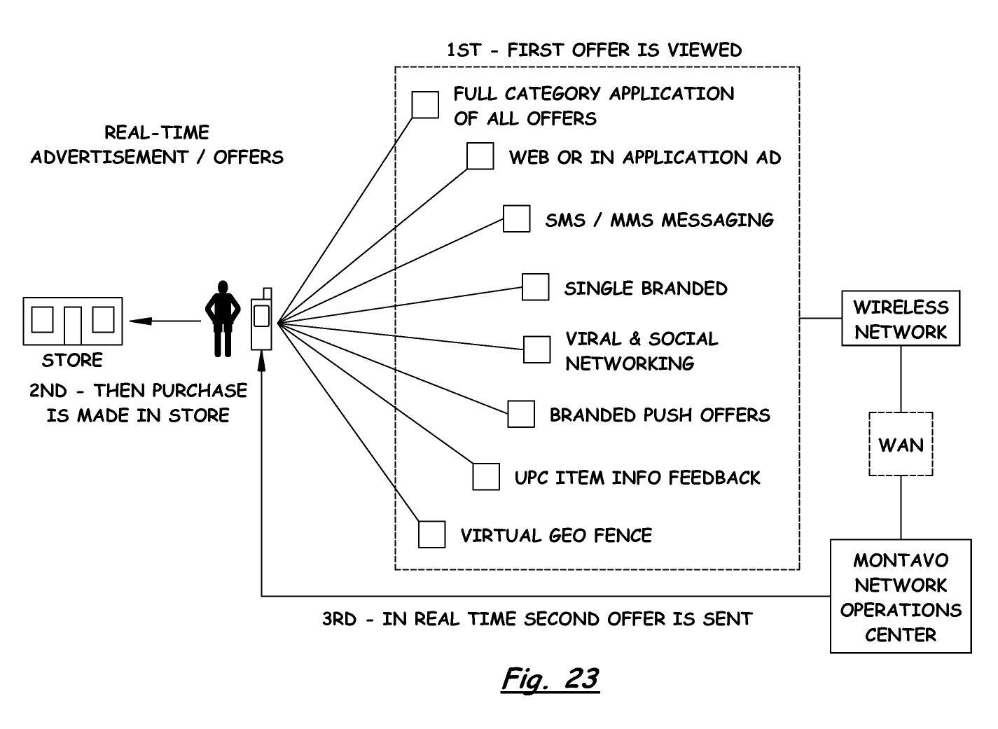

An illustration showing how the report 125 is generated is shown in FIG. 19. A copy of a report 125 as presented on a computer display is shown in FIG. 20. Optionally advertisers 300, 400 can run custom and or pre defined reports 125 through a menu of available parameters of all the data made available to the advertisers 300, 400 based on the all information in the system 10.

One thing a national brand can do is run a test market with the system to do a campaign just in city A and a campaign in city B to test the results before running it across the entire nation.

An example of how a custom report 125 can be run is a national brand advertiser 300 could zoom into one store (of 1,500), take the ads shown to have been delivered within 2 miles of the store, on one day being today, between 1 PM and 3 PM, on one item advertised of the 14 ads they are currently running, for males, between 20 and 29 years of age, for just the ad search engine distributed out of the nine ways the system 10 advertises on the mobile devices and display the cost of this one adverting component on the system to review the ROI ratio of ad dollars spent to sales revenue and profit.

Alternatively a custom report 125 could be run that is a national brand advertiser 300 could zoom out to all 1,500 stores, unlimited distance away from the stores, over a week, until yesterday closing time on all stores, on all 14 items that are currently running, for both males and females, for all ages, for all nine ways the system 10 advertises on the mobile devices and display the cost of this to review the ROI ratio of ad dollars spent to sales revenue and profit.

### End User Ad Database Search Engine Embodiment

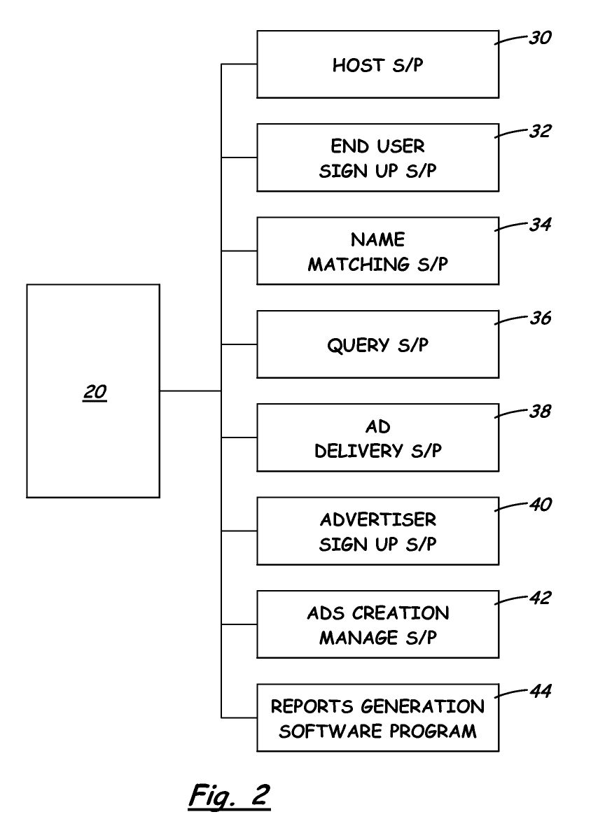

As shown in FIG. 1, the ad delivery service 11 operates a system server 20 that is connected to the wireless network 220. As shown in FIG. 2, loaded into the system server 20 is a host software program 30 that enables the system server 20 to communication with a mobile client application 176 loaded into each mobile device 160 that enables the mobile device 160 to communicate with the system server 20. In addition to facilitating communication between the mobile device 160 and the system server 20, the mobile client software program 176 is used by the end users 12 to submit search parameters from the ad discovery application 178 bundled in the client side software program 175. The ad discovery application is linked to an ad discovery search engine 22 located on the system server 20. The ad discovery search engine 22 uses a variety of different ways for an end user 12 to search for ads 25. One way is a category directory tree structure with sub categories, another way allows end users to input and search for key words (some other possibilities include product categories, subcategories, descriptions, trademark, manufacturer, seller, nature of ad, price, etc.). During use, end users 12 may submit search commands to the ad discovery search engine 22 that searches the ad folder 88 created in each advertiser's file 82 and stored in the advertiser's database 80 linked to the system server 20. Results from the search are then sent back to the mobile client application 176 on the end user's mobile device 160

It is a unique feature of the system that groups of brands can be favored over other groups. This can be the case in such an example the National Brands are always on top of the list not matter what they for example my pay per ad delivered or per store location or any other what would be called secondary parameter. This is evident in that some might normally say who pays the most per ad is on top. But in this case it is a unique feature that who pays the most is only on top of a favored group. This affects the displaying of the ads on the mobile device.

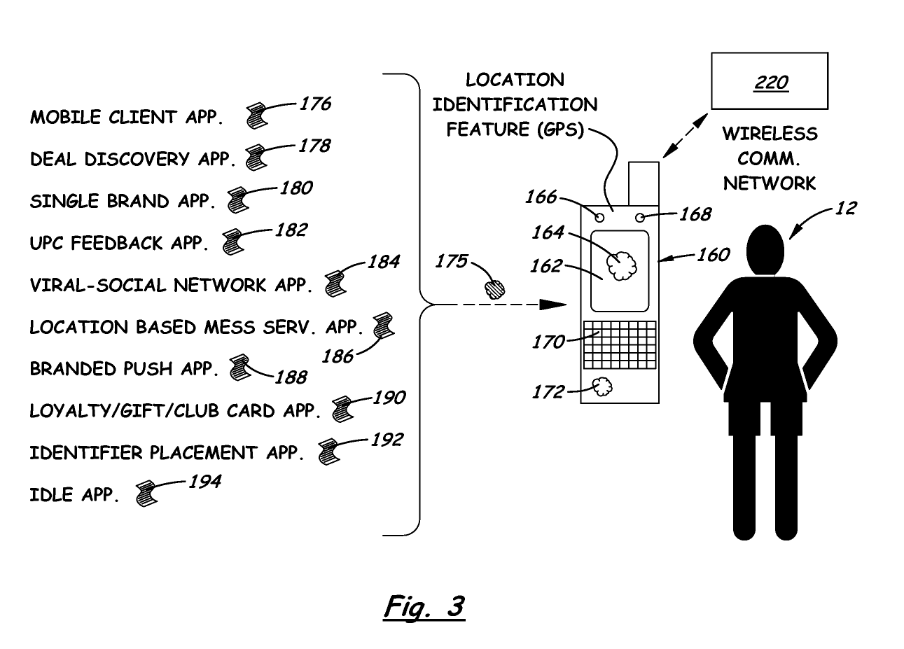

FIG. 3 is an illustration showing a mobile device 160, such as a mobile phone, adapted to communicate with a wireless communication network 220. The mobile device 160 includes a display 162, a browser software program 164, a location identification feature (i.e. GPS transceiver) 166, a camera 168, input keys 170, text SMS/MMS messaging software 172, and a client side software program 175. The client side software program 175 which is loaded into the mobile device's working memory, contains a bundle of other software applications used by the system 10, such as a mobile client application 176 used to communicate with the system and server 20 and to associate the mobile device with a registered end user 12 and a deal discovery application 178. The client side software program 175 may also include a single brand application 180, a UPC feedback application 182, a viral marketing social network application, 184, a location based message service application 186, a single branded push application 188, a loyalty, gift, and club card application 190 as discussed further below. Optionally, an identifier placement application 192 can be included the client side application 175 that can be to place or repeatedly place outside the client software program 175 somewhere else on the device a software code that makes the mobile device 160 identifiable when the code is found and or read by another software code or program.

The mobile device 160 may be is identifiable on the system 10 in several ways. First, if the end user 12 is using the deal discovery application 178, the mobile client application 176 includes in the bundle automatically communicates with the server 11. All the pertinent actions are then recorded. This is the same for all the client side software application listed here and above here. The second way for identifying the mobile device 160 is through the use of the ad network which is discussed and presented below. This has to do with any of the systems' ad delivery ways that are messaging and or banner ad type where the end user is not currently using one of the client software programs. The one way the system server 20 knows which end users received an ad 25 is through the SMS and MMS service where the end user's phone number is used to send the message ad. In this case, the phone number can be copied back the the system sever 20 and thus the system 11 knows a particular or plurality of particular end users received the SMS and or MMS message ads.

A third way for the mobile device 160 to be identified by the system 10 is that the system server 120 knows an SMS and MMS type message ad was delivered to a end user's mobile device is that the message ad has an executable component to it in that when the ad is delivered it is able to run an executable software program and auto communicate back to the system server that this particular device has received a SMS and or MMS message ad and in addition pass back the identifiable information to the system server 20 so as the end user is identified (generally this is done only due to the client side software program 175 being installed on the mobile device 160 to set this possibility up).

A fourth way of the mobile device 160 to be indentified on the system 10 is when the the system server 20 knows a banner ad was delivered to an end user's mobile device in either for example a web site and or a different other programs such as a game software application is that the banner ad is delivered to the mobile device with software code that when the banner ad comes up (not even clicked on) the code searches for either the software client 175 or 175 and or other advertising service provider installed software programs and or the identifier code place somewhere on the device outside the mobile client application 176 175 in order to identify the end user 12 who uses the mobile device 160. Then the code delivered with the banner ad and or other software on the device communicates and reports back the system server 11 that the particular mobile device associated with the end user received a banner ad (and this is done without clicking on the banner). Every ad generated and delivered out to each individual, that is all consumers has a individual unique ad ID that is tracked an recorded so as to be able to be used for all the reports 125.

The Mobile device is identifiable in several ways by the system 11. One if the end user is in the mobile client software application 175 using the deal discovery application 176, the software is automatically communicating with the server 11 and all the pertinent actions are being recorded. This is the same for all the client side software application listed here and above here. The other way that the mobile device is identifiable for the system 11 is through the ad network features discussed and presented below. This has to do with any of the systems' ad delivery ways that are messaging and or banner ad type where the end user is not currently using one of the client software programs. The one way the server 11 knows which end users received an ad is through the SMS and MMS service where the end users phone number is used to send the message ad. In this case the phone number can be copied back to the system sever 11 and thus the system 11 knows a particular or plurality of particular end users received the said SMS and or MMS message ads.

Another way the system server 11 knows an SMS and MMS type message ad was delivered to a end users mobile device is that the message ad has an executable or similar type component to it in that when the ad is delivered it is able to run an executable or similar type software program and auto communicate back to the system server that this particular device has received a SMS and or MMS message ad and in addition passed back the identifiable information to the system server so as the end user is identified (generally this is done and only possible due to the software program 175 being installed on the mobile device to set this possibility up).

Another way the system server 11 can know a banner ad was delivered to a end user device in either for example a web site and or a different other programs such as a game software application is that the banner ad is delivered to the device with software code that when the banner ad comes up (not even clicked on) the code searches for either the software client 175 or 176 and or other advertising service provider installed software programs and or the identifier code place somewhere on the device outside the mobile client software 175 in order to identify the end user who uses the device. Then the code delivered with the banner ad and or other software on the device communicates and reports back the system server 11 that the particular device associated with said end user received a banner ad (and this is done without clicking on the banner).

All this is vitally important to the entire system as then banner ads, SMS message ads, and MMS message ads can be used in reports to be able to tell if an end user who received one of these ads went into a physical location store and purchased. And all this is able to be reported in the reports 125 to the advertiser.

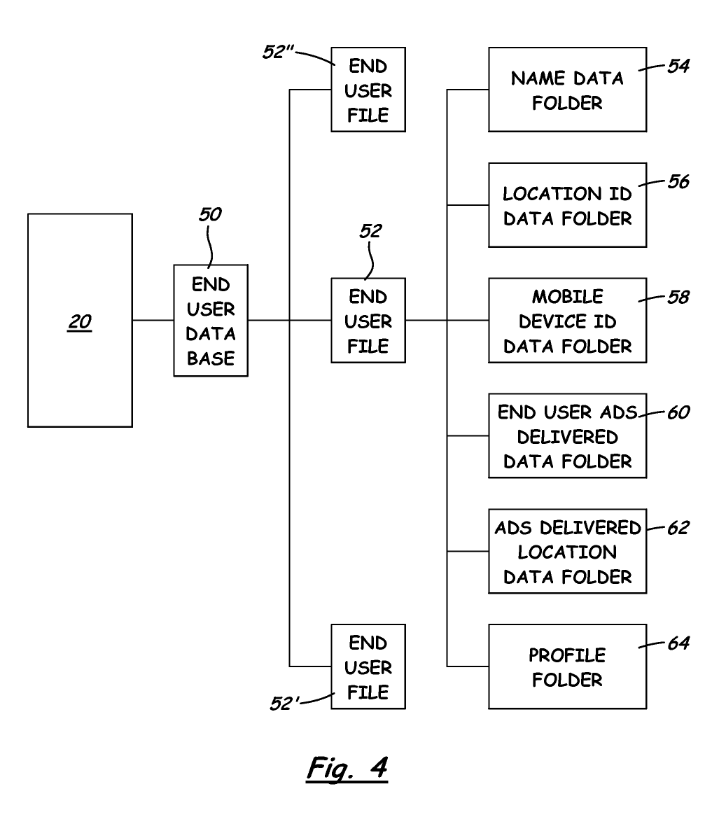

After each end user 12 has registered with the service 10 either on a regular website of the internet or directly from the mobile device 160, the mobile client software program 175 is automatically or manually downloaded from the system server 20 to the mobile device 160. During the sign-up process, a minimal amount of information is requested from each end user 12, (i.e name and at least one location identifier, city name or zip code), which is stored in the name data folder 54, and location ID data folder 56 as shown in FIG. 4.

A host registration software program 52 that is loaded into the system sever 20 looks for the end user registration software program 56 on the mobile device 160 when initial contact through a verity of different ways but one for example might be through a web browsers to the service providers web site from the mobile device is made by an end user 12 to determines whether the individual is registered on the system 10. If the mobile client software program 176 is not found, the system server 20 in that web session informs the individual that he or she is not a registered end user 12 and that he or she must do so in order to use the service 10. The system server 20 then gives the individual an opportunity to become a registered end user 12 by completing the sign-up process controlled by the mobile client application 176 and the host application. Each time the end user 12 attempts to use the system 10, the system server 20 confirms the presence of the mobile client software program 176 on the mobile device 160. It is understood that a different person can changed the end user information associated with the software program 175 on the mobile device 160 so as the system server 20 would know it is now a different end user associated with the particular device.

As shown in FIG. 4, the system server 20 includes an end user database 50 a plurality of end user files 52 each containing a name data folder 54, a location ID data folder 56, a mobile device ID data folder 58, an end user ads delivered data folder 60, and an ads delivered location data folder 62. As stated above, the end user's name and location information and mobile device ID data information is inputted and save in the name data folder 54, location ID data folder 56, and mobile device ID data folder 58, respectively. The end user ads delivered data folder 60 contains a plurality of ads 25 delivered to the end user. The ads delivery location data folder 62 contains location information of the end user when the ads 25 listed in the ads delivery data folder 62 are delivered to the end user.

FIG. 2 is a diagram of the system server 20 showing the software programs 30-44, that are loaded into its memory. As discussed above the host software program 30 is used to communicate with the mobile client application 176 on the mobile device 160. Also shown is an end User sign-up software program 32 used to sign up end users 12 on the system 10. A Name matching software program 34 is used to find matching names of end users 12 that received ads 25 in an advertiser's ad folder 86 and the names of customers in the advertiser's sales transaction database 95. A query software program 36 is to identify the names of end users 12 that actually received ads and then completed a sales transaction at the advertiser's store. Ads delivery software program 38 is used to send selected ads 25 to all or a select group of end users 12 signed up for the service 11. An advertiser sign-up software program 40 is used to sign up advertisers 300, 400 to the service 11. Ads creation and management software program 42 is used by advertisers 300, 400 to create new ads 25 or to modify existing ads 25 in their respective ad folder 88. A report generation software program 44 used by the system server 20 to generate the reports 125 that contain the number of end users 12 who received ads 25 conducted a sales transaction thereby enabling the advertisers 300, 400 to determine the overall effectiveness of the service 11 and the ads 25.

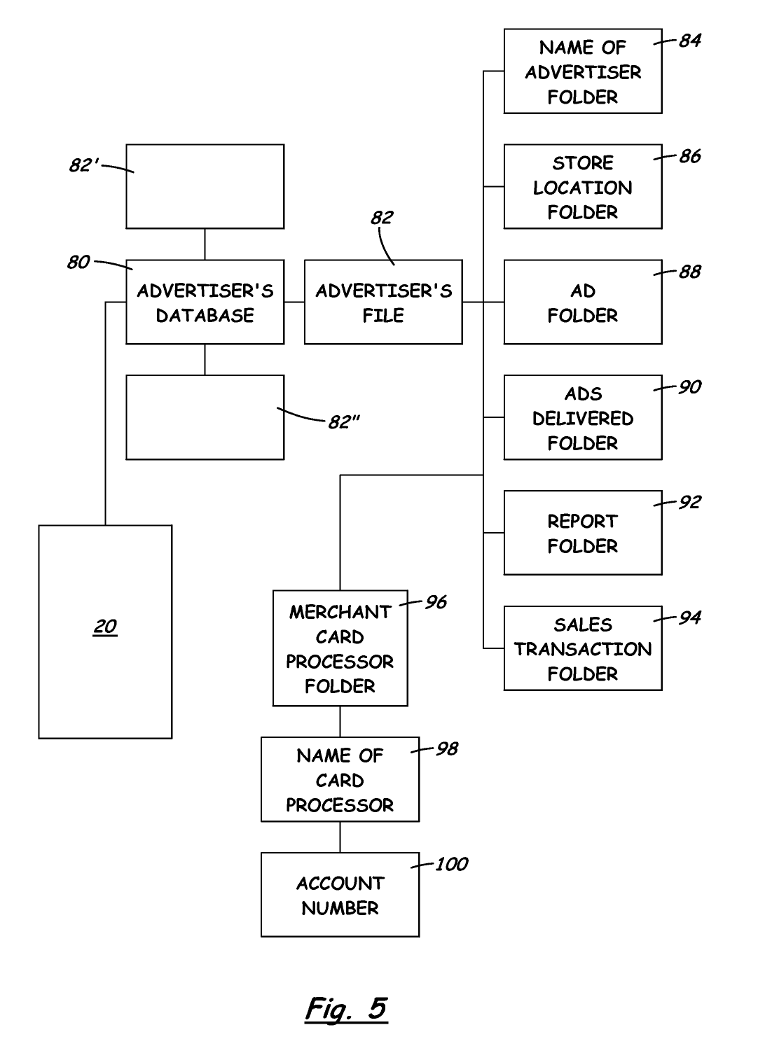

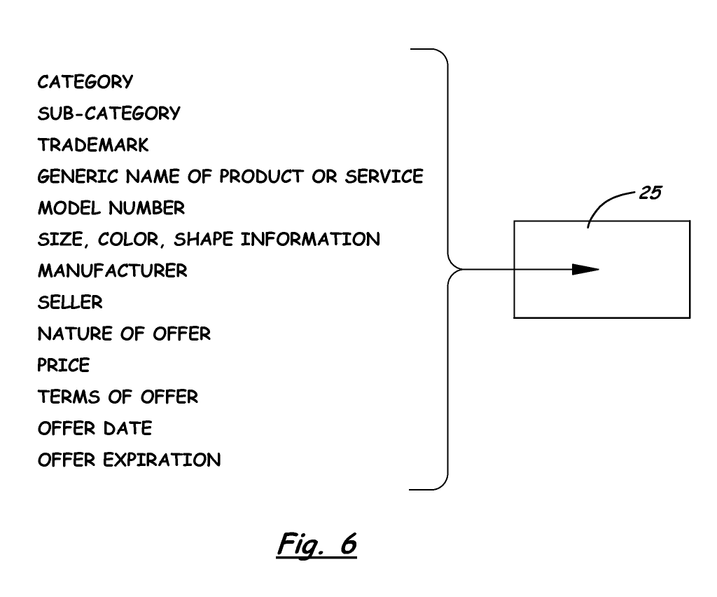

When an advertiser 300, 400 signs up for the service 11, the system server 20 creates an advertiser file 82 for each advertiser 300 or 400 in the advertiser database 80. As shown in FIG. 5, each advertiser file 82 contains a name of advertiser folder 84, a store location folder 86, an ad folder 88 containing ads 25 that have been or will be delivered by the service 11, and a report folder 92 containing reports 125 prepared by the service 11. Also, each advertiser file 82 may include an optional sales transaction file 94 containing sale transaction records from the advertiser's stores that are then used to generate the reports 125.

As discussed further below, small/mid-size advertisers 400 typically use external merchant card processing companies to process the credit and debit card transactions conducted at their physical stores. FIG. 5 also depicts a merchant card processor folder 96 typically created in the small/mid-size advertisers 400 advertiser's file 82. The merchant card processor folder 96, typically includes a name of the card processor sub-folder 98 that contains the name of the card processor used by the small/mid-size advertiser 400 and an account number sub-folder 100 that contains the advertiser's account number at the card processor. It should also be noted that the matching of end users that received ads and the customers that purchased products or services can be done on the system 20 server if the entire sales transaction data base is sent to the system serve 20 or can be done on a remote server 230 located at the merchant card processor of the advertiser 400 or if it is a national brand advertiser 300, on a remote server 230 located at the national brand advertisers 300 network operation center and then only the matches and relevant data the the mated sales transaction data is needed to be sent to the system server 20.

### National Brand Advertiser Embodiment

As stated above the system 10 is designed to be used with large companies, called national brand advertisers 300 that operate or sell products and services in a plurality of physical stores in a large region and use one or more internal merchant card processing facilities to processes all of their credit and debit card transactions conducted at their physical stores. Typically, when the national brand advertiser 300 signs up for the service 11, an advertiser file is created on the server 20 and the name of the advertiser, the store locations are recorded in the files 84, 86, respectively. An ad 25 is then created and stored in the advertiser's ad file 85. The national brand advertiser 300 then instructs the system server 20 when to deliver the ad 25 to all or some of the end users 12 through a verity of all the ways the system server 11 allows ads to be distributed. When an ad 25 is delivered to an end user 12, a record of the ad 25 is record in the advertisers ad delivery file to the end user 12 and all the relevant information regarding its delivery including but not limited to a unique id number and how or which way the ad was delivered to the device. It may also be recorded in the end user's file.

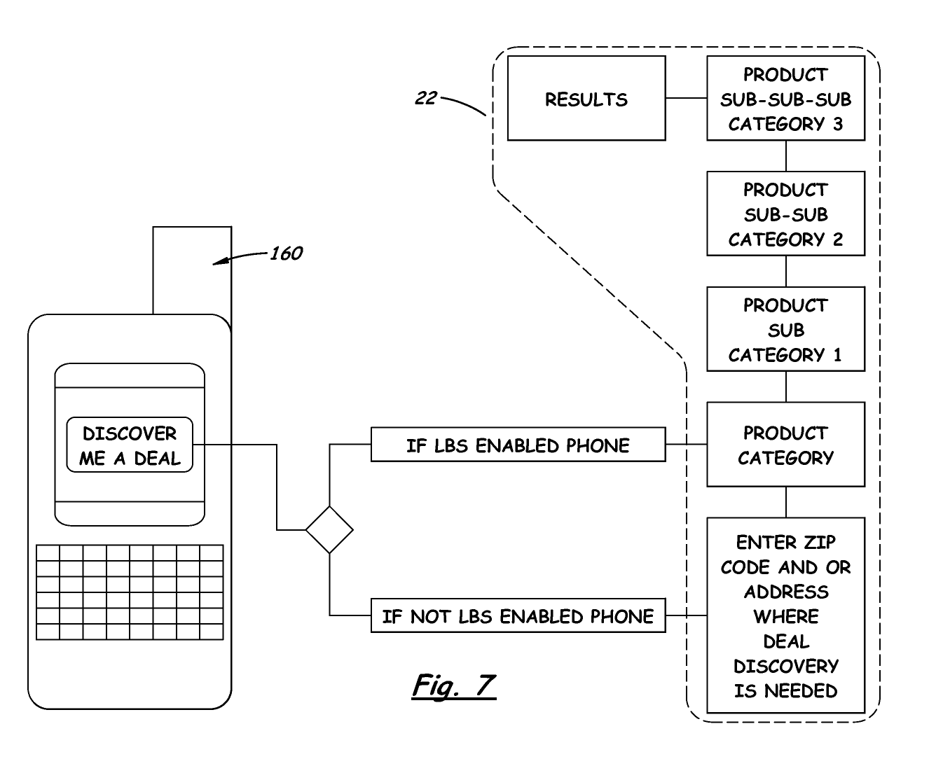

As stated above, the deal finding software application 178 is loaded into the mobile device 160 that connects to the search engine 22 located on the system server that then allows an end user 12 to search all or some of the advertiser's database for ads for a particular good or service. The search terms submitted to the search engine 22 must be associated with the ad 25 as shown in FIG. 6 The search results are then presented as a menu on the display on the end user's mobile device 160 as shown in FIG. 7. The end user 12 can then request that all of the search results be delivered to the mobile device 160 or only selected ads be delivered to the mobile device 160. When the ad 25 is delivered to the mobile device 160 and subsequently opened on the display, the nature of the offer in the ad 25 is in more detailed reviewed as shown in FIG. 7. In most instances, the ad 25 is time and date stamped and optionally recorded with many other parameters.

If the end user 12 then visits a store operated by the advertiser or a store where the ad 25 will be honored as if it is a coupon, or if the advertiser 300, 400 is a manufacturer and the store sells the manufacturer's product or service advertised, and then completes a sales transaction for the product or service listed in the ad 25 using his or her credit card or debit card, the transaction must be recorded in the advertiser's sale transactions database or the retailer selling the manufactures product or service sales data base. As mentioned above, national brand advertisers 300 typically operate a plurality of physical stores in a large region and use one or more internal merchant card processing facilities to processes all of their credit and debit card transactions conducted at their physical stores or at least keep all the information related to the sales transaction in an internal advertiser network operation center. The sales transaction records may be associated to a particular manufacture in the case where the advertiser is a manufacturers but the sales transaction data for the advertiser manufacture is coming from a retail stores sales transaction data base. In some instances, more than one internal merchant card processing facility may be used that are networked together.

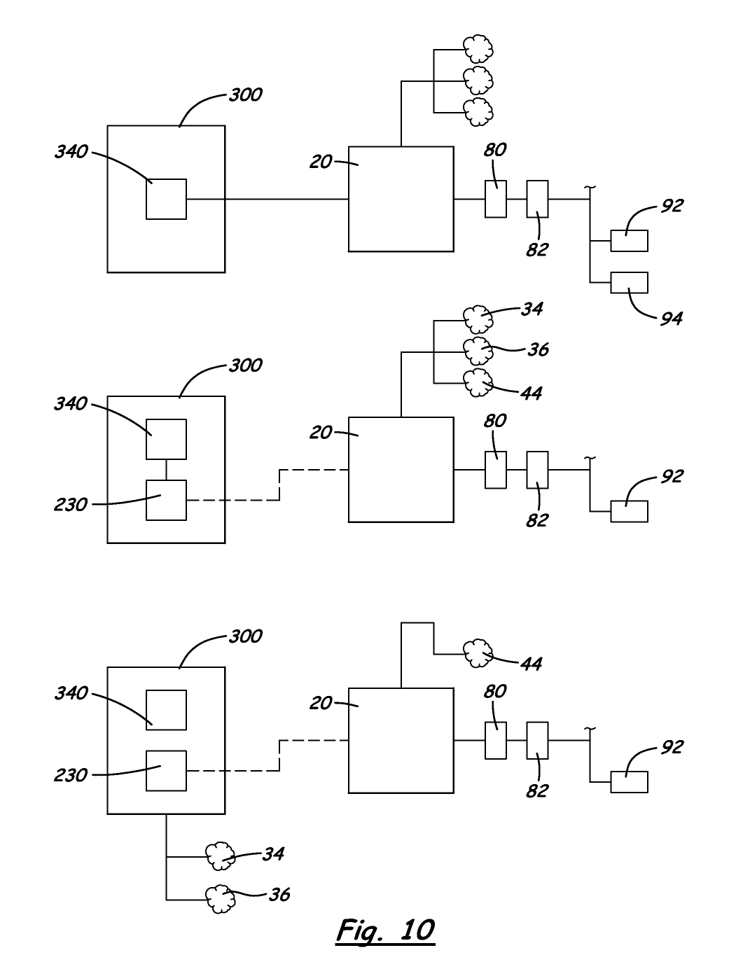

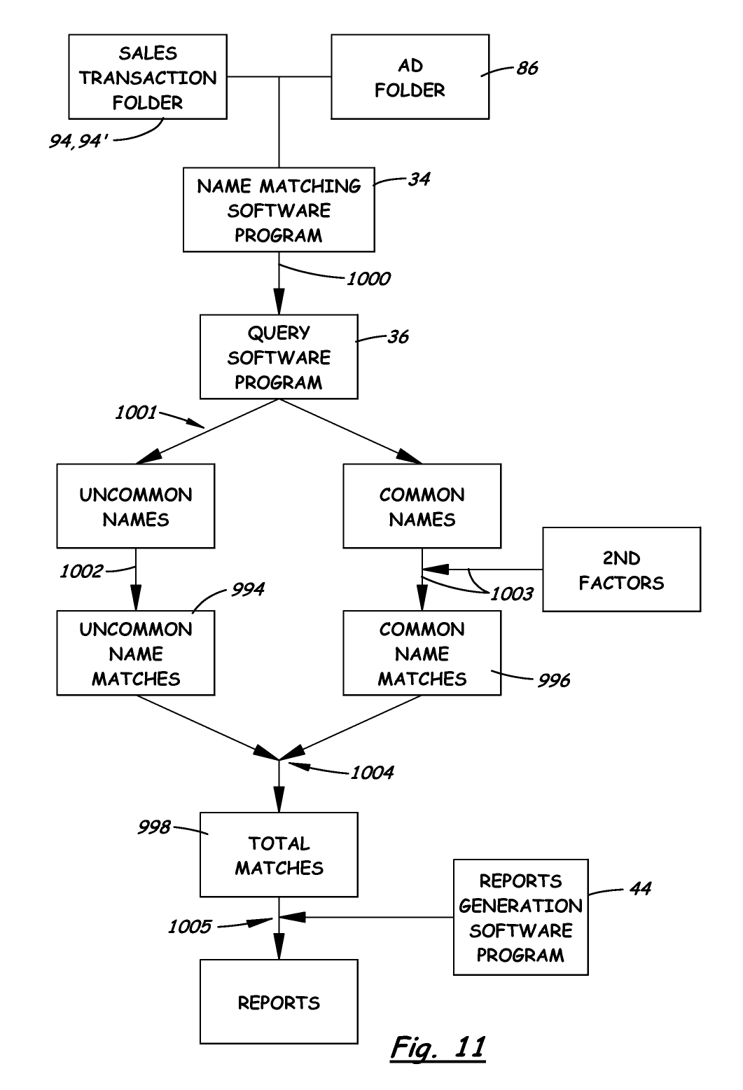

In FIG. 10, advertiser's sales transaction database 340 is located at the advertiser 300. In the first embodiment, the system server 20 is directly connected to the sales transaction database 340 and copy of the records in the database 340 are placed in the advertiser's sales transaction database 94 located on the system server 20. In the second embodiment, a remote server 230 located at the advertiser 300 is adapted to connect to the sales transaction database 340. Sales transaction data from the remote server is then processed by the system server 20. In the third embodiment, the remote server 230 is also located at the advertiser 300 and adapted to connect to the sales transaction database 340. The remote server 340 makes a copy of the sales transaction database and then uses the name matching software program 34 and the query program 36 to finding matching results that are then delivered to the system server 20. A report generating software program 92 is then used to prepare final reports 125 for the advertiser 300.

As illustrated in FIG. 11, once the sale transaction folder 94 or 94′ folder is available to the system server 20, the name matching software program 34 on the system server 20 or on the remoter server 230 then examines the names of the end users who received ads 25 recorded in the ad folder 86 and the names of customers in the sales transaction folder 94, 94′. A query software program 34 located on the system server 20 or on the remote server 230 then analyzes the combined name information (step 1000) and sorts the names into two groups: Uncommon name group and common name group. For uncommon names, the query software program analyzes (step 1002) the name data for matches. For names placed into the common name category, a second filtering step (step 1003) that uses secondary factors to identify name matches 996. Once the uncommon and common name matches 994, 996, are determined, they are then combined (step 1004) by the query software program 36 to create a total matches file 998.

As stated above, the above matching steps may be completed on the system server 20 or on the remote server 230. If this is done on the remote server 230, the matches and related information is then sent to the system server 20 for further processing. A reports generation software program 44 located on the system server 20 is then used to analyze and present (step 1005) the information in the total matches file 998 in a final report 125 as discussed above. It is important to understand that the communication and system can both encrypt and anonimize all the data between the remote server 230 and the system server 20. This is done through an encryption software program 244 on the remote server 230 and on the system server 20. The anomization process is completed by a data anonimizing software program 246 running on both the remote server 230 and the system server 20.

It is also important to note that in relation to the outside bank or merchant processor 290 that clears the credit or debit card transactions for the advertiser 300 retailer, that they also use the remote server 230 to exchange all the necessary data for the advertiser 300 with the system 10 for a national brand or small/mid-size business manufacturer advertiser that the goods or services are sold in a store where the sales transaction occurred and the merchant processors clears the credit card sales for.

### Small/Medium Business Embodiment

It is important to understand that for the small/medium business that many to all of the same features as listed for the national brand are the same or substantially the same as listed above and vs versa. The system 10 is also designed to be used by a small to mid-size business 400 that use an outside merchant card processor or bank 290 to process its credit card, debit card or gift card transactions 415 completed by end users 12 who visit the advertiser's physical store 412 When the small or mid-size advertiser 400 initially signs up for the system 10, an advertiser's file 82, name of advertiser folder 84, a store location folder 88, an ads delivery folder 90 and report folder 92 are created as shown in FIG. 5. In addition, a small or mid-size business credit card processor file 96 is created on the system server 20 that contains the names 98 and contact information for the small/mid-size business' merchant card processor 290 used by the small/mid-size advertiser 400. Associated with the name of the card processor 98 is a merchant account number 100. When a credit or debit card transaction 415 is completed at the small/mid-size business store 412, a sales transaction record is created which is then stored in the sales transaction database 292. In most instances, the sales transaction database 292 is maintained at the merchant card processor 290. A copy of the sales transaction database 292 may be sent to the system server 20 and stored in the sales transaction file 94 located thereon. Alternatively, a remote server 230 may be provided that is linked or connected to the merchant card processor 290 and is given secured access to the sales transactions database 292. In some instances, a copy of the sales transaction database 292 delivered to the remote server 230. Once access to the original or a copy of the sales transaction database 292 for the small/mid-size advertiser 400 has been provided, the system server 20 or the remote server 230 is then able to run the names matching and query software programs 34, 36 to determine which end user's (using name, location, time and other factors) that received an ad actually became a customer and completed a purchase at the advertiser 400. It is again important to note that if the name matching and query steps are done at the remote server 230, then only the final collection of matching data is sent to the system server 20. It is also again important to note that the small/mid-business advertiser 400 could be a manufacturer and is able to access a plurality of sites or stores through one or a plurality of external merchant processors 290. Each merchant processor 290 could be assigned to one remote server 230 that is shared by all sites or stores.

After the matching data and filtering steps are completed, the system server 20 than runs the reports generation software program 44 to generate the final reports 125. The same final reports 125 generated for the national brand advertisers 300 may be prepared for the small/mid-size advertisers 400

It is important to understand that the communication and system can both encrypte and anonimize all the data between the remote server 290 and the system server 20. This is done through an encryption software program 244 on the remote server 230 and on the system server 20. The anomization process is completed by a data anonimizing software program 246 running on both the remote server 230 and the system server 20.

It is also important to note that in relation to the outside bank or merchant processor 290 that clears the credit or debit card transactions for the advertiser 400 retailer, that they also use the remote server 230 to exchange all the necessary data for the advertiser 400 with the system 10 for a national brand or small/mid-size business manufacturer advertiser that the goods or services are sold in a store where the sales transaction occurred and the merchant processors clears the credit card sales for.

### Ad Aggregator Embodiment

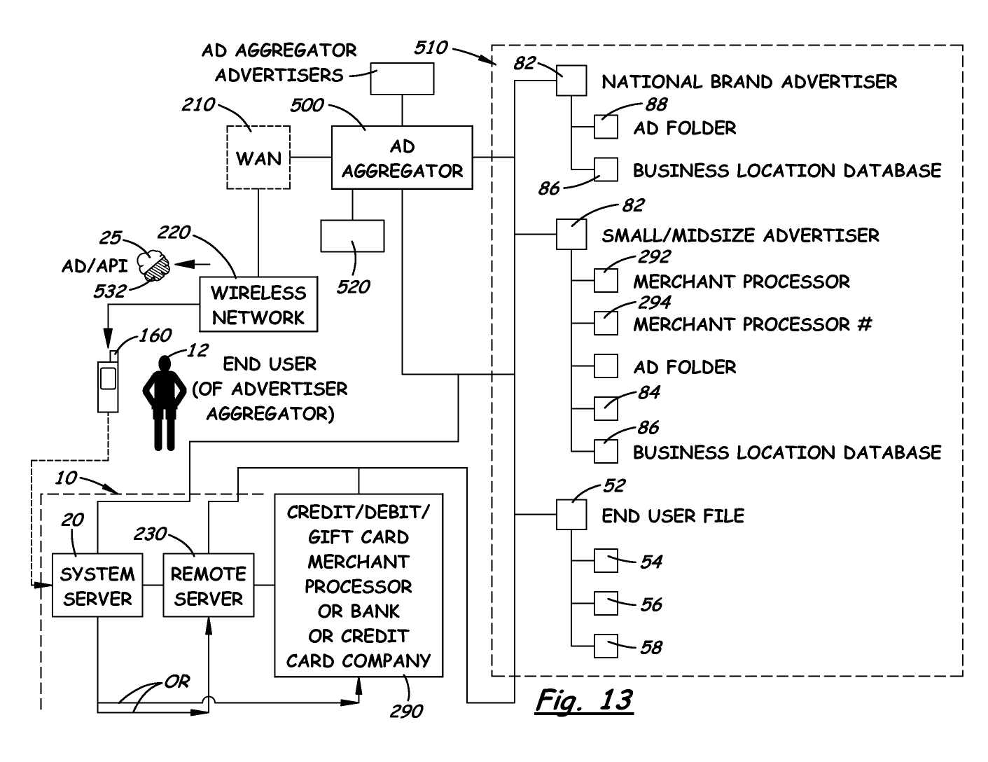

FIG. 13 is a diagram showing one type of ad aggregator 500 that sells and delivers their own inventory of mobile advertisements for its own advertiser clients 520 and then provides the same reports 125 to the advertiser clients 520 that are provided to the national and small or mid-size advertisers 300, 400 as described above. The system 10 is now made available to the ad aggregator's advertiser clients 520 via the aggregator's system that interfaces with the system 10. Alternatively, the ad aggregator 500 may use the system 10 as a complete private labeled solution for them. In order to use the system 10, the same information collected for the national and small/mid-size advertisers 300 or 400 must be provided for each ad aggregator's advertisers 530. The information may be directly inputted into the system 10 or via an API 532 from the ad aggregator 500. The information is then stored on the system server 20 but all information associated with the ad aggregator is mark as such so information can be reported as related to the ad aggregator and or their ad clients.

An ad aggregator database 510 on the system server 20 for the ad aggregator 500 is substantially identical the advertiser's database on the system server 20. The ad aggregator database 510 also needs to contain a national brand advertiser sub-account 300′ that contains an ad folder 88, and a business location database 86. The aggregator database 510 also contains a small/mid-size advertiser account 400′ containing the names folder 84 containing the names of each small or mid-size advertiser, a business location folder 86, a merchant processor account file 292, a merchant account number file 294 and an ad folder 88. The aggregator system database 510 must also contain an end user file 52 contain subfiles 54, 56, and 58 that contain the names, locations and ad delivery information, respectively. Once all of the above information is collected by the ad aggregator 500, a copy of the entire database file is then sent to the system server 20 and stored in the ad aggregator database 80 shown in FIG. 1.

On the system server 20, an application protocol interface (API) 532 is created for each ad aggregator 500 and all the information that is sent through the API is mark as associated with the particular ad aggregator.

When the ads 25 are sent out and distributed from the ad aggregator 500, they contain substantially the same technology and parameters as when the service 11 sends them out. When the end user 12 receives the ad 25, the API 532 is then forwarded to the system server 20 and or also when the end user 12 receives the ad 25 the items function the same as when an end user 12 receives an ad directly from the service provider and the communication between the end user 12 can be directly to the service providers' system 11. Thus, when an end user 12 and or a non-registered end user receives an ad 25, they operate in the same way in connecting and reporting to the system 10 and the same signup requirements and input information for all the end users are applied. As an option all the reporting information can be sent through the API 532 to the ad aggregator 500 for them to offer reporting to their advertising client 520.

As an option, if there are two separate systems 10 running under two separate service providers 11 or if one service provider 11 is running two systems 10, then the two or more systems 10 can communicate with each other so as to have all data available to all entities communicating with the system 10 or receiving and or viewing reports 125.

A second type of ad aggregator usage is where the ad aggregator 500 is simply inputting ads 25′ into the system 10 through the API 532 and not delivering ads from their own system. Again, all the ads 25′ are marked as this ‘ad aggregator’ and all other parameters operate the same way. Also, as an option all the reporting information can be sent through the API 532 to the ad aggregator 500 for them to offer reporting to their advertising client 520.

### Push Messaging Ad Network Embodiment

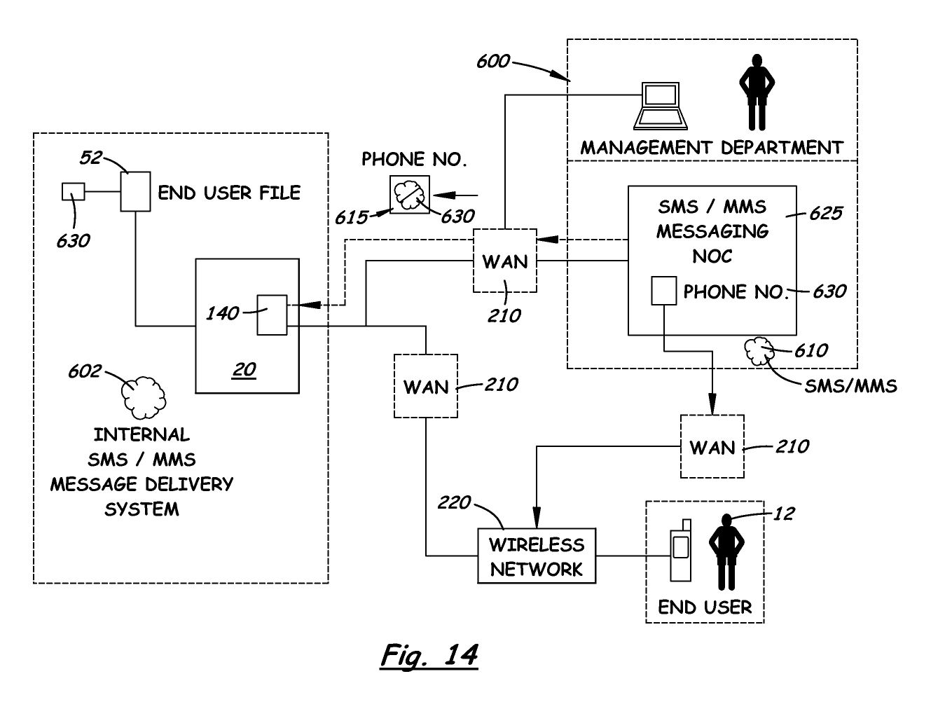

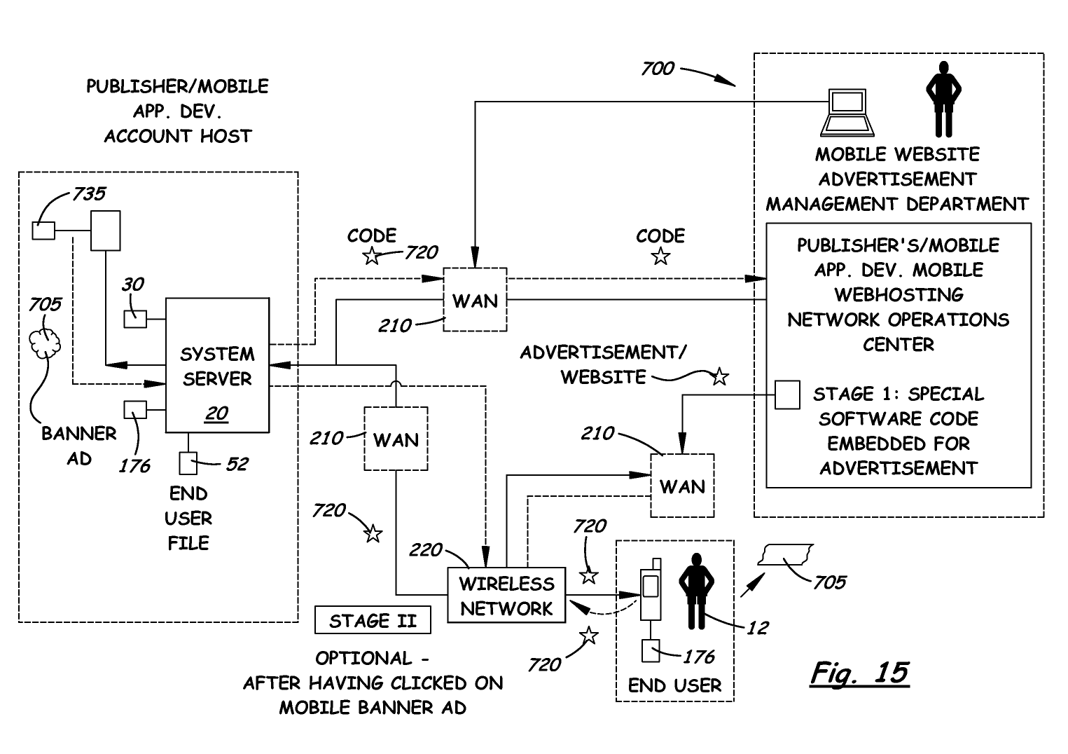

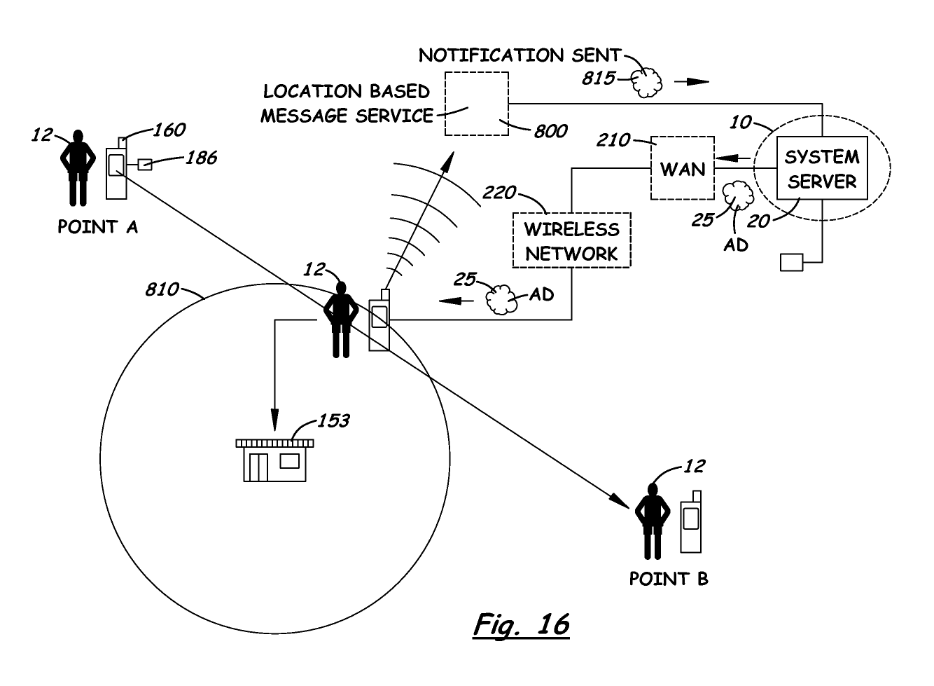

FIG. 14. is a diagram showing the system 10 used with an outside SMS/MMS message delivery service 600 coupled to the system server 20. It should be understood that the system 10 could be coupled to an internal SMS/MMS message delivery service, generally indicated by the reference number 602. With the outside message delivery service 600, the system 10 tracks the phone number 630 of the SMS/MMS consumers that receive the ads 25. A final report can be prepared by the system that uses the phone numbers of the consumers that received the ads 25 and matches them with the phone numbers 630 (stored in the end user's folder 52 on the system server 20) of registered end users 12. Again all kinds of optional reports can be run as stated in the reporting section of this embodiment but the main report here is which end users were delivered an ad and thus which of those that were end user and were delivered and ad went into a store and purchased a advertised product or service.

When the SMS/MMS message 615 is delivered, optionally it can be delivered with an advertising link that if ‘clicked’ will either execute a program or take the consumer to a web page that will display an ad and also optionally will read if the consumer is a end user or a non-registered end user as is outlined and listed above and below here to be done. The non-registered end user may be shown the full extent of the ad or may be given the option or forced to downloading the client side software program 175 and signing up for the system 10 first in order to see the full ad. Later, the system server 20 or remote server 290 will review the sales transaction records of the advertiser to determine if the end user 12 completed a credit or debit card sales transaction. If the consumer is already a registered end user, then he or she is regarded as a registered end user 12 and is shown the full ad 25 right away as they are already signed up. The registered end user 12 does not need to download the client side software program 175 as they already have it and installed it. Again in both cases, or an end user and a non-registered end user all the parameters are recorded for the advertiser to review in custom generated reports 125.

Optionally, the SMS/MMS message can be designed to auto start the mobile client application 176 or some other type of executable program or when the consumer opens the message, or clicks on the SMS/MMS message such option can happen, or when visiting a web page from a link of the SMS/MMS message such option can happen. In each instance, the system 10 determines if the consumer is a registered end user 12.

The distributor 625 can be paid to deliver SMS or MMS messages 615 to customers for a specified amount or it can be paid a percentage amount of the ad revenue from the service provider 10. Either way the ad cost of this feature can be loaded into the system 11 so as to be able to run the reports 125.

Another advantage of the above described system is that if an outside 3^{rd} party SMS or MMS distributor is used, the distributor can be further incentivized by the fact that the system records which consumers were already end users and which consumers were non-registered end users matched from the phone numbers messages they were sent to. And when a non-registered end user becomes a registered end user, the information is recorded and credited to the outside third party SMS and or MMS distributor as being responsible for a non-registered end user becoming a registered end user. The advantage of such a system is that then a portion of the revenue from the advertiser to the system provider 10 that delivers ads to the end user 12 and the mobile device 160 that the third party SMS and MMS distributor was the entity that was responsible for the end user 12 becoming a registered end user, that for all ads that are in the future delivered to that mobile device the distributor can be paid a specific or percentage amount for of all the ad revenue to the service provider to that specific new registered end used the SMS/MMS distributer is responsible for converting to a registered end user. This is major advantage of the system in that also the SMS/MMS distributor could be paid in many other ways or percentages of the ways the service provide is compensated such as a percentage of the advertisers sales revenue or profit.

### Banner Ad Network Embodiment

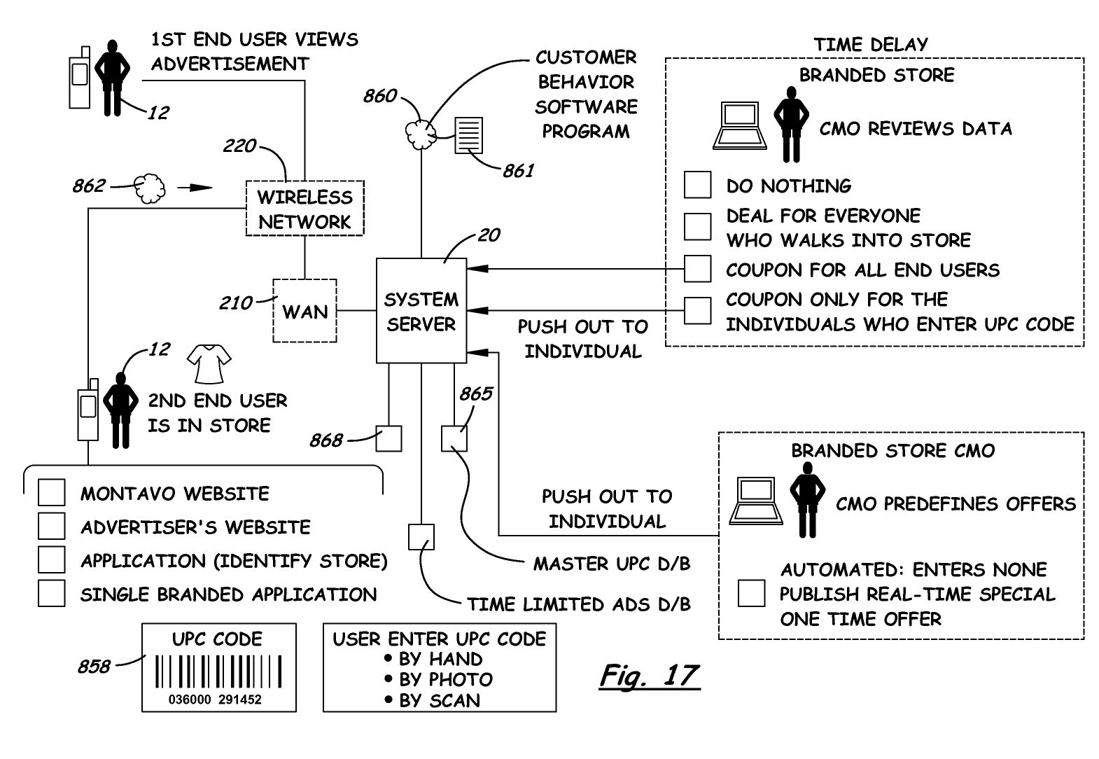

It is important to understand that for the banner ad network that many to all of the same features as listed for the SMS/MMS are the same or substantially the same as listed above and vice versa. FIG. 15 is a diagram showing, a banner ad network 700 coupled to the system 10 in which, or as an option a third party banner ad distributor 702 can distribute the banner ads 705, or the system 10 can act as its own banner ad network and distribute its own banner ads.

Banner ads can be distributed to either for example a mobile device web sites and or mobile device software applications. These two types of entities, mobile device web sites and or mobile device software application developer each sign up for and create an account on the system server 20. When an account is created, a code 720 is assigned to the entity which become embedded into their banner ads that are used when their respected webpage or applications are used. When the banner ad on the website or in the application is uploaded to the end user accessing the web page or application, the code 720 is delivered to the viewer's mobile device 160.

If the viewer of a banner ad is a non-registered end user, then when he or she ‘clicks’ on the banner ad or website link, the viewer is shown the full ad details or offered the option or is forced to sign up for the system 10 before seeing all the details of the ad. After signing up for the system 10, the entire banner ad 25 may be shown. Whether or not the viewer is a registered end user 12 is determined by the host software program 30 on the system server 20 determining if the mobile client application 176 or other identifier is found on the mobile device. If a viewer is a registered end user 12 and clicks on the banner ad or link, then the entire banner ad or webpage is displayed and this action is recorded on the ads delivered folder 735 located on the system server 20. If the viewer is a registered end user 12 and yet does not ‘click’ on the banner ad or link, the code 720 is still recorded in the ad delivered folder 735 if it can find the client software or another identifier and thus report the end used associated with the device back to the system server 11. The system server 20 then uses the codes recorded in the publishers/mobile application developer file to determine the total number of ads delivered to registered end users. Using this information, the system server 20 can review the sales transaction database of the advertiser, as described earlier, to determine if the end user 12 completed a sales transaction. Because the system is able to determine if some of the viewers who received a banner ad or link completed a sales transaction, the advertiser will find the system more valuable. It should be understood, that the entity that actually delivers the banner ad network distributor can vary.

If the viewer is not a registered end user so that when the banner ad or link is clicked, the code is delivered to the system server 20, delivery of the banner ad is still recorded which may be valuable to some advertisers or banner ad distributors.

### Geo Fence Embodiment

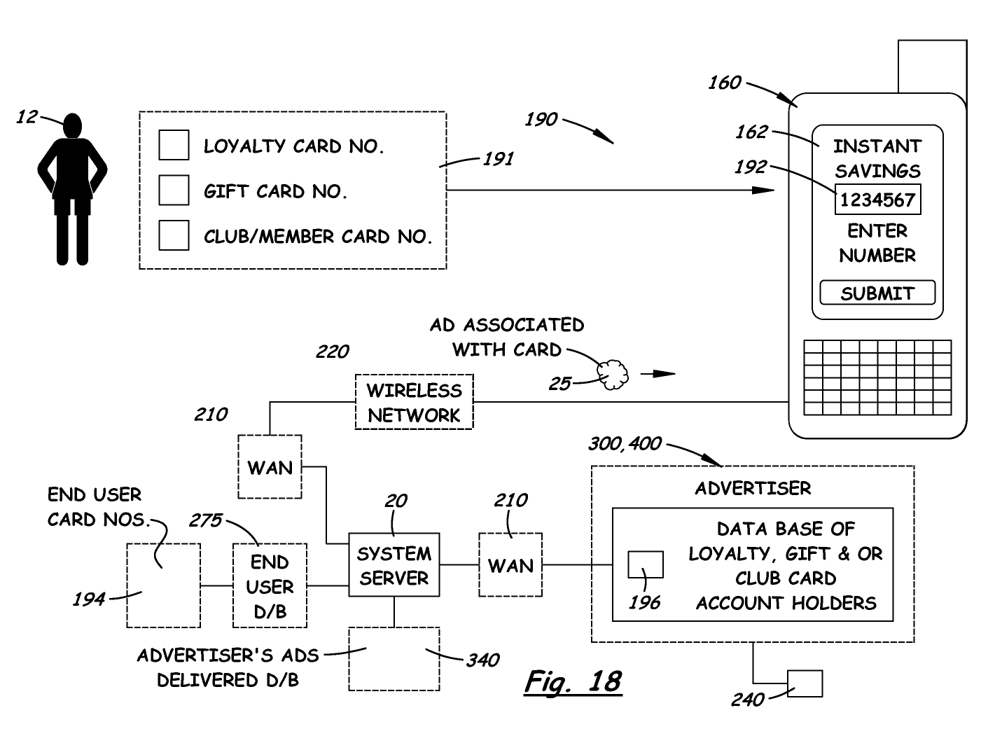

FIG. 16 is an illustration showing the system 10 being used with a location based message service 800 that notifies the system server 10 when an end user 12 is in the vicinity 810 of the advertiser's store 153. The system server 10 then delivers the advertiser's ad 25 to the end user's mobile device 160. Generally via SMS/MMS and this ad also contains code or instructions for the end user to open their client app 175 for a further more in detail ad related to the SMS/MMS ad message they just received, Also if the end user does not open their client side program 175 soon, then possibly the next time the end user 12 opens their client side 175 the more detailed ad will still be there for their viewing.

In this embodiment, a location based message service application 186 is downloaded into the mobile device 160 (normally with the client side software program 175). The application 186 can be automatically or selectively activated by the end user 12. This is used in determining the mobile device location and or just when a location around an advertisers store is or has happened in the device entering or exiting this virtual geo fence area set around the advertiser's store (again it can also be a manufacture advertiser that the device is close to a retail store where the advertiser manufacture's products are sold). It is also possible that the wireless carrier through a wireless network location service can provide this information and or integrated with the system 10 or an outside third party providing the service. As the end user 12 moves in the region, a notification is sent to the system server 11 informing the system of the end user's location in that a virtual geo fence has been trip and a message needs sent to the end user 12. In order for this to occur, associated with each advertiser is a store database 820 informing the server 20 of the store' location. A map software program 830 is then used to determine when the end user 12 is in the range or entering the vicinity 810 and whether the end user 12 exited the vicinity 810.

When the end user 12 is in the vicinity 810, the system server 20 then transmits an ad from the advertiser's ad folder 88 to the end user 12. The sale transaction records in the sale transaction folder 34, 92 and the end user's information in the ad folder 88 are then compared and matched by the matching and query software programs. Reports are then prepared by the report generating software program.

### UPC Feedback Embodiment

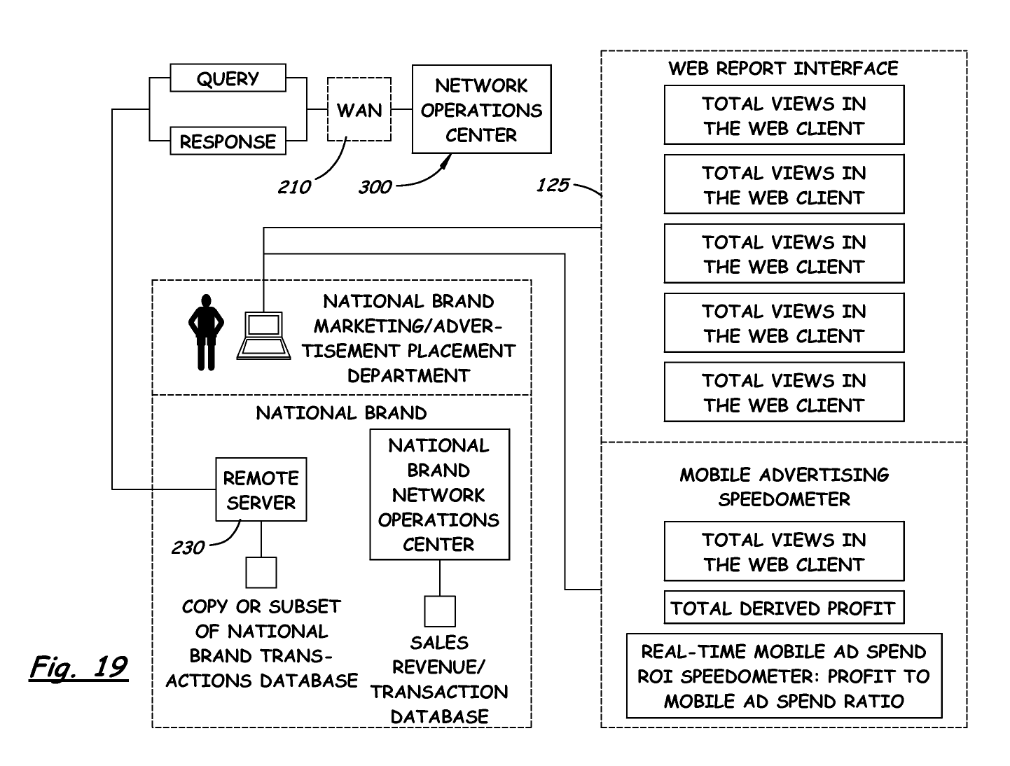

FIG. 17 is an illustration showing the system used with a UPC feedback feature in which end user's who provide feedback concerning the price, quality, features, or other feedback of a product or service offered by an advertiser may be sent back other information or offers. When the end user 12 signs up to use the system 10, the end user 12 is given the option of downloading a UPC feedback application 180 into the mobile device 160 or it is included in the download and installation of the software 175 or the feedback can be done from a web site. The UPC feedback application 180 must be loaded into the mobile device 160 in order to use the UPC feedback feature.

Prior to purchasing the good or service, the end user 12 either manually inputs the UPC 858 into the system server 20. The UPC 858 may be entered using the UPC feedback application 180, or visiting the advertiser's website, or the advertiser's mobile client software single branded solution. If the mobile device 160 is suitably equipped, the UPC 858 may be submitted by a camera 168 or barcode scanner. When the UPC 858 is inputted, optionally the end user's comments about the product or service (typically the price) is inputted.

Located or linked to the system server 10 is a customer behavior software program 860 that optionally presents a menu 861 listing the nature of the feedback information 862 desired by the advertiser (is the price too high? Blue, red, etc). Also, located or linked to the system 10 is a master UPC database 865 that contains the UPC codes for a plurality of products sold by the advertisers.

The feedback information 862 may be stored in the advertiser's feedback file 868 either on the system server 20 or the advertiser's business (not shown). The advertisers may either review and respond to the feedback information 862 immediately, or on a time delayed basis. When the feedback information 862 is received, the advertiser may on a time delayed bases (1) do nothing; (2) offer a discount or coupon for the product or service to all consumers in the world and through other media advertising too as well as sent a message to all the registered end users that are associated to the advertiser on the single branded solution and thus opted in to the advertiser to received communications in the form of push messaging to them; (3) offer a discount or coupon only to end users of the system that submitted in feedback for the UPC item in question.

As an instant feedback the advertiser can have an advantage of only incentivizing the end user 12 on a real-time bases that needs incentivizing and thus the advantage of the system 10 is that the other shoppers that come into the store and will purchase the product or service at say for example full price are not given a discount as none is needed for them to purchase the item. This way the advertiser maximizes their profits. The way this works in the UPC database has the records of special UPC deals that are only accessible by submitting the UPC to the system 10. When this is done the system 10 can see that the advertiser set this as an instant feedback UPC item and thus when this UPC code 858 is received from an end user 12, the system 10 sends back a coupon that is only good for example for 20 minutes before expiring. This is the incentive the end user needs to purchase the item immediately without lowering the price for the other shoppers that are willing to pay full price.

### Loyalty Gift or Club Card Embodiment

FIG. 18 is an illustration showing a loyalty, gift or club card service 190 that can be use with the service by a retailer or manufacture, a national brand advertiser 300 or a small/mid-size advertiser 400. In this scenario, the end user 12 has one or more loyalty, gift, or club membership cards, generally indicated by the reference number 191, each assigned a unique card number 192. The end user 12 inputs the card number 192 into his or her mobile device 160 or the service provider's web site. The card number 192 is saved in a end user card number file 194. The advertiser 300, 400 also saves the end user's card numbers 192 in its account holder's database file 196.

During use, an ad 25 that contains an offer that requires the end user 12 to present the card or the card number 191 is sent to the end user 12. When the end user 12 wants to search for ads for the particular good or service, he or she conducts a search on the ads folders on the system server 20 or if an ad is delivered in some other way to the end user 12 on their mobile device 160. When the end user 12 finds or is delivered or views on any of the ways the system 10 delivers an ad 25 to the end user 12 a desirable ad for the good and service that requires a card 191 or its number 192, the end user 12 stores the offer in the saved ads folder created by the mobile client application 176 on the mobile device 160. In most instances, the ad 25 is also delivered by the system 10 to the advertisers' database file 196 also and also optional is the ad 25 information is sent to the advertiser or the retailer that sells the product advertised but mainly to the entity that is or has the loyalty or club card. When end user 12 visits the advertiser's store or website and completes the transaction with his club or loyalty number, the offer is usually applied at the time of purchase but could be a delayed credit back such as the coupon example described below here. At the time of purchase, the end user 12 must present his or her loyalty, gift, or club card 191 or the assigned number 192. The transaction is recorded in the advertisers 300, 400 sales transaction database.

### Single Advertiser Branded Solution Embodiment

The single branded solution is the same feature set and functions as the end used ad data base search engine and mobile client software in that the only main differences is that only brands and messaging and ads that can be accessed or viewed or interacted with while in the mobile client software (or if it is set up as a separate doorway in to the mobile client software) is that particular brand advertisers ads.

An advantage to this is that one, the advertiser has their company logo present and predominantly placed on the end users 24—7 personal mobile device. A second advantage to the advertiser 300, 400 is that since only the brand advertisers ads can be viewed or interacted with it means that other distractions from other brands cannot be hitting the end user and none of the competitors to the brand advertiser are available either since there is no comparison shopping via multiple ads and messages from multiple competing brand advertisers. It is only that brands ads and messaging that is being given to the end user and thus the end user is much more focused on that particular brand advertiser. This is a critical advantage as this builds strong and lasting brand loyalty and awareness factors with the end user.

All of this is tracked on the system server and thus available through all the custom reporting features of the system 11.

### Push Messaging Ads by Advertisers Embodiment

It is set up in the system 11 that an advertiser can push ad messages out to registered end users. Although this can be done to all registered end users it is mostly done through an opt in scenario where an end user has opted in to receiving push ad messaging from the advertiser via there accepting an opt in or accepting an opt in via accepting the advertisers single branded solution of the mobile client software as an opt in acceptance through a terms of use agreement that was agreed to at the time of software and or feature was install.

The messages can be push out in several different formats and ways, but two ways is one through sending an SMS or MMS ad message to the registered end user, OR, two is sending a ad message to the mobile client application running on the end users mobile device such that the next time the end user opens and runs their mobile client software (if it was not already running or running in the background) the end user receives and sees the ad sent to the end user.

All of this is tracked on the system server and thus available through all the custom reporting features of the system 11.

### Virtual Marketing and Social Networking Embodiment

End users who receive ads from the system 11 can chose to forward them to Friends, Family, Co-Workers, and Others. Also the system 11 can be hooked into 3^{rd} party social networking sites to have ads forwarded to others via the 3^{rd} party.

The ad can be forwarded in multiple different ways but some examples is via SMS, MMS, and or to the mobile client application if the system is able to determine that the consumer who is to receive the forwarded ad is a registered end user on the system.

Generally the system would work in that more than one forward of the ad would be conducted in that a SMS or MMS would go out to the receiving consumer. This would then be the same process as stated in the push messaging embodiment in that the consumer receiving the ad an end user or a non-registered end use and follow that process as stated in that section about sign up for the service or not and or if and when they can view the entire ad and message.

One of the optional advantages of the system 10 is that the forwarding of the ad can be with a personal message too, but may not be with all the details or fully viewable of the ad or personal message. This is so as the consumer must open the ad and or personal message to see all the details and if they are not a registered end user they may need to and or be required to register and install the mobile client software to see and review the full ad and or full personal message. It is an advantage that the ad and personal message is coming from someone they know and trust and has for example maybe a personal message about something like “meeting at 5 PM”. And since the consumer (weather end user or non-registered end user) knows and trusts who the message and or ad is coming from they have a much higher likelihood of opening the message and ad and seeing it in its entirety. Also if the consumer is not a registered end user it is also much more likely the non-registered end user will follow through with fully registering to become a registered end user in order to see the full personal message and ad.

All of this is tracked on the system server and thus available through all the custom reporting features of the system 11.

### Idle Mobile Device Screen Sound Vibration Embodiment

Another software component of the mobile client software is the idle screen and or sound and or vibration notification mobile device push ad 25 feature. This is an optional feature set by the system provider about how often the mobile device would self turn on for example and beep a sound and or vibrate the device and or turn on the screen to then display an ad.

All of this is tracked on the system server and thus available through all the custom reporting features of the system 11.

### Other Possibly Ways to Advertise on the Mobile Device Embodiment

The system is set up to push out ads or have the end user pull ads in. It is contemplated that other means of pushing and or pulling ads will in the future be added to the system 11. The main point is using all the components and technologies listed here in the system 11, any new ways of having ads pushed or pulled to mobile devices, the same as all the current ways listed here, can without any wireless data connection in the store or at the point of purchase, without any retraining of personal in the store, without any interaction between the mobile device and the store personal or the cash register, and without any interaction between the customer end user and the store personal and or the POS and still tell if an end user who received an ad went into the store and purchased as outlined in the system 11 and technologies listed here.

All of this is tracked on the system server and thus available through all the custom reporting features of the system 11.

### Mobile Coupons Embodiment

The mobile device coupon feature is an advantage over other systems in that there is no: wireless data connection in the store or at the point of purchase needed, it is done without any retraining of personal in the store, done without any interaction between the mobile device and the store personal or the cash register, and done without any interaction between the end user and the store personal and or the POS.

From the figures XX through XX when the end user clicks on the button to redeem the mobile coupon right when they are purchasing the product at the POS the system 11 receives the request to use the coupons from the end user with all the related information to the ad that is a coupon and same as with the other regular ads that are not coupon ads. But in addition, in the coupon case, additional information is added in that when the end user presses the button on the redeem coupon while purchasing the items at the cash register POS system the end users location and the time and the date is added and sent to the system server and all the mobile coupon ad information. Also optional is a return message of confirmation that all the needed and pertinent information from the end user and mobile coupon was properly received by the system 11 to process the coupon and send them their credit to their card they purchased the item on. The system 11 runs through all the matching processes as outline here and above and if a match is found the additional step is conducted of sending the match confirmation to the retailer who conducted sale so as to the retailer can credit back the matched end user purchase with the said amount of the coupon. If the coupon ad is from a manufacture advertiser and not the store that made the sales transaction the system will make available a report so as the store and the manufacture can conclude a payment or cross credit of some type between the two of them (being the retail store that purchased the advertised item from the manufacture and the manufacture that supplied the store with the item to sell in the first place that was advertised with the coupon).

All of this is tracked on the system server and thus available through all the custom reporting features of the system 11.

### Real Time Push Ad After Item Purchase

In another push ad feature the system 10 can tell that a end user has made a purchase in a store and then immediately send a new ad 25 to the end user. This ad 25 sent can even be a related ad to the purchase the end user just made.

All of this is tracked on the system server and thus available through all the custom reporting features of the system 11.

### Self or Future Locate Feature

It is a feature of the system and client software the that end user can self locate themselves in the current time or where they plan to be in the future

All of this is tracked on the system server and thus available through all the custom reporting features of the system 11.

### Four Major Components to Run Entire System Embodiment

The entire system works in an eco system matter that is a major advantage and non obvious over anything current in that all four major components work in concert to form the eco system. The four major components are: the mobile client software, the back end business intelligence of having the retail stores sales database either at the system server 11 or on the remote server, the ad delivery network via push banner ads and or SMS and MMS, and the eco system part the creates the system in that if an advertiser uses the system to entice consumers to become registered end users with the mobile client software on their mobile device, that makes it so all advertiser on the system can now benefit from all the features and reports list in the system even if it is a different advertiser that does not have a or the initial relationship with a registered end user—the one that signed up due to the other advertisers efforts.

For example retail store advertiser #1 places ads on the system and has mobile ads pushed out in banner ads and SMS ads over the system network and some consumers who are not registered end users become registered consumers. Then advertiser #2 (manufacture or retailer) then places ads on the system and has mobile ads pushed out in banner ads and SMS ads over the system network. Even if the end user does not click or anything with the banner ads or SMS message ads the system still knows some of who was sent or received the banner ads and or SMS messages to and thus can tell if a registered end user purchased produces or service from the advertiser #2 even though the end user never click on or interacted in any way with the ad other then reading and viewing it. And yet the system can still run the reporting features and custom reports and show who or which registered and or identifiable end users purchased the product or services related to the advertiser #2.

All of this is tracked on the system server and thus available through all the custom reporting features of the system 11.

The four major components are:

ONE: The Eco System—First a plurality of brands spends major amounts of their mobile interactive marketing budget on the push mobile ad network for banner ads and SMS/MMS. Out of all these ads delivered a plurality of end users become registered end users (thus all the software is now loaded on the end users mobile device with the capability to identify the end user by the system now). It is also noted that many devices for several reasons may be preloaded to the end user and or the end user may sign up for a verity of other reasons. The end result is the Eco system part of the method and system is that many end users do to the technology here will already have the mobile client software on their device and thus when a new advertiser XYZ comes to start advertising many of their push banner and SMS/MMS ads will already be able to be confirmed as delivered to registered end users and thus be able to see if they went into the physical store and purchased products. The main key here is all the advertisers are helping each other in that the new advertiser XYZ also achieved some success by their mobile ad spend in that it incentivized some non registered end users to become registered end used like the advertisers before them. Soon all end users or a very large number will be registered end users.

TWO: Ad network—in that the system must have the ad network that also delivers the code with the banner ads and or the system also gets back the phone numbers of the SMS/MMS ads that were delivered ads too. This is absolutely key in that without the ad network that is delivering the say banner ads to expanded the eco system and deliver the code to report back to the system server which end users are receiving the ads there would be no way to confirm the end user went into a physical location store and purchased products or services.

THREE: Mobile client software—without the mobile client software there would be no way or reason for the end user to register and or have the identification of the end user with the device and the indentify code placed on the device that the banner ad code read and send the identification of the device and end user back the server of who received a banner ad. And again thus would not be able to tell who from receiving ads went into a physical store and purchased.

FOUR: Business Intelligence/Business Appliance/Enterprise Software—hardware & software solution in the data mining of the retailer's sales transaction database: This is needed in order to confirm the registered end user went in to the physical store and purchased product or services. The technology stated above here is how to connect the broken link in that consumers will only give a very very limited amount of personal identifiable information (such as their name only). Consumers will not give their Checking account #'s. Credit Card Numbers, store credit card numbers, Social Security Numbers, and other personally identifiable items, and many of these number and information change over time too and become obsolete and you would need to check for all of these information to make a direct match. Thus the technology listed above is very unique in its way of connecting the broken direct link between a end user that received an ads in one of the 10 ways listing above here and the customer in the store and figuring out via several processes listed here in this technology that they are indeed one in the same.

As such the system and method here with all the four major components and all the technology listed above here an advertiser can tell with 10 different ways of marketing on the mobile device that a end user who received an advertisement via one of the 10 different ways of marketing on the mobile device that the end user went into a physical store and purchased a product or service. And this was done with zero wireless data connection in the store, no retraining of any store personal, no interaction between the end users device and the cash registrar POS or the store personal, and no interaction between the end user and the store personal or the cash register POS. And the advertiser can have real-time dash board reporting of the ROI via the mobile ad spend dollars ratio to the sales revenue and or profits. Which is the number one most important cost matrix the advertiser is looking for and can only get via this method and system.

In summary, the above system 10 may be used with both large and small/mid-size advertisers, that operate physical stores and sell products and services to customers. In should also be understood that ‘advertisers’ may be any store operator or owner, any product manufacturer or distributor, or any service provider that that sells their products or services to customers or through a retail store not owned by the advertiser. It should also be understood that any sales or promotional communication is considered an ‘ad’ used in the system 10. Examples of an ad may be an electronic coupon, a e mail offer, a banner ad, a website or a hyperlink. In should also be understood that even though a mobile device as been depicted in the Figs, the system 10 may be used with other types of device, such as smart phone, laptop computers, netbook devices, and portable electronic reading devices.

It should also be understood that even though the invention has been described where ads are sent to the end user after submitting a request (called pull technology), the system is not limited to this. The system server 20 may be setup to send ads to end users at any time (called push technology).

In compliance with the statute, the invention described herein has been described in language more or less specific as to structural features. It should be understood, however, that the invention is not limited to the specific features shown, since the means and construction shown, is comprised only of the preferred embodiments for putting the invention into effect. The invention is therefore claimed in any of its forms or modifications within the legitimate and valid scope of the amended claims, appropriately interpreted in accordance with the doctrine of equivalents.

I claim:

1. Mobile shopping and advertising information system, comprising;
a. a wireless network;
b. at least one end user;
c. mobile device associated with each user, each said mobile device is assigned a unique mobile device identifier, has ad or message receiving capability and is able to communicate over said network;
d. at least one advertiser;
e. an advertiser's sales transaction database associated with each said advertiser, said advertiser's sales transaction database containing the purchase/transaction name or identifier of consumers who purchase goods or services of said advertiser;
f. a system server connected to said wireless network;
g an end user profile database containing the purchase/transaction name or identifier and said mobile device identifier operated by said end user;
h. an end user account signup and management software program to input purchase/transaction name or identifier of said end users and said mobile device identifier into said end user database;
i. an advertiser database containing the names of advertisers and their store locations;
j. a software program to input the names of said advertisers and their store locations to said advertiser database;
k. an ad database containing a plurality of ads, each said ad having a publication lifespan;
l. an ad creation and management software program to input said ads and their respective publication lifespan into said ads database;
m. an end user ads delivered database containing a plurality of end users profiles assigned to each said end user, each said end user profile containing the ads delivered to said end user and the date and time of delivery of the ad, each ad delivered in said profile being associated with a location end user location;
n. an ads delivery software program to deliver ads to said end users;
o. an ads delivered recording software program that saves ads delivered to said end user to said ads delivered database; and
p. a query software program that creates a database containing the matching names of purchase/transaction names or identifiers in said advertiser's sales transaction database of said end users who received advertiser's ad in said end user's ads delivered database, said query software program uses one more secondary filtering factors to more accurately match the records in said said sales transaction database and said records in said en user's ads delivery database.

2. The system as recited in claim 1, further including a report generating software program that uses database created by said query software program to generate a report that shows an estimated return on investment

3. The system as recited in claim 2, wherein said second filter factor also includes one of the following: how long the ad is published; how long offer is valid; or a system designed time period after the ad is delivered.

4. The system as recited in claim 2, wherein said second filtering factor is the location of said end user when the specific ad received and where the goods or services are purchased as recorded in said sales transaction database.

5. The system as recited in claim 4, wherein said second filter factor is one of the following: how long the ad is published; how long offer is valid; or a system designed time period after the ad is delivered compared to when the ad was delivered to said consumer.

6. The system as recited in claim 1, wherein said end user database is located on said system server.

7. The system as recited in claim 1, wherein said end user account sign and management software program is downloaded from said server to said mobile device.

8. The system as recited in claim 1, further including a host software program on said server and a mobile client software program on said mobile device that enables said server and said mobile device to communicate.

9. The system as recited in claim 1, wherein said query software program is located on said system server.

10. The system as recited in claim 1, further including a business application server associated with at least one said advertiser, said business application server being used to communicate with said system server.

11. The system as recited in claim 10, wherein said advertiser's sales transaction database, said query software program and said end user's ads delivery database is connected to said business application server.

12. The system as recited in claim 11, further including a report generating software program that uses database created by said query software program to generate a report that shows an estimated return on investment

13. The system as recited in claim 12, wherein said second filter factor also includes one of the following: how long the ad is published; how long offer is valid; or a system designed time period after the ad is delivered.

20. An wide area network ad delivery and payment system, comprising:
a. plurality of end users, each end user associated with a mobile device assigned to a unique mobile device identifier;
b. at least one advertiser;
c. an advertiser's sales transaction database associated with each said advertiser, said advertiser's sales transaction database containing the purchase/transaction name or identifier of consumers who purchase goods or services of said advertiser;
d. a server used to transmit one or more ads to said mobile devices associated with said end users, said ads delivered to said end users being saved is an ads delivered database
e. a query program that reviews said advertiser's sales transaction database and said ads delivered database for matching names contained therein; and;
f. a report containing the cost of transmitting an ad to said end users based on the number of matching names in said sales transaction database and said ads delivered database.

15. A method for determining the economic effectiveness of an online advertising campaign that use ads are pulled or pushed to mobile devices operated by potential end users, said method comprising the following steps:
a. creating a database containing the names or identifiers of a plurality of potential end users, each said potential end user being associated with a mobile device with a unique identifier;
b. creating an ad for a good or service for an advertiser to be pulled or pushed to some or all of said potential end users in said database;
c. assigning a cost of goods or services to be sold or the profit margin percent of sales revenue of said goods or services in said ad;
d. transmitting said ad to said mobile device operated by potential end users;
e. monitoring the names of identifiers of customers who purchase a good or service listed in said ad;
f. determining if the customer who purchased a good or service listed in said ad is an end user who received said ad via their mobile device;
g. generating a report that presents the total revenue of said goods and services advertised and were purchased by said customers who received said ad via their mobile device as determined in Step (f); and,
h. generating a report that presents the total profit of goods or services purchased by said customers who received said ad via their mobile device using the total revenue determined in Step (g) minus either the cost of goods or services purchased by said customers who received said ad via their mobile device or multiplied by the profit margin percentage as provided in Step (c).

16. The method as recited in claim 15, further including the step (i) wherein the total profit of goods or services determined in step (h) is divided by the cost of the advertising program to provide the return on investment of said advertising program.

17. The method as recited in claim 15, further including the step (i) in which the cost of the advertising program minus the total profit of goods or services as determined in step (h) determines the return on investment of said advertising program.

18. The method as recited in claim 17, further including the step (j) in which the cost of the advertising program minus the total profit of goods or services as determined in step (h) determines the return on investment of said advertising program.

19. The method as recited in claim 16 wherein said report generated in step (h) is determined and reported for each good or service listed in said ad.
